(19) United States
(12) Patent Application Publication
(10) Pub. No.: US 2025/0276649 A1
(43) Pub. Date: Sep. 4, 2025

(54) ADJUSTABLE STORAGE BINS

(71) Applicant: MULLEN TECHNOLOGIES, INC., Brea, CA (US)

(72) Inventors: Aaron Marin, Lake Forest, CA (US); Robert Huotari, Irvine, CA (US); Mark Jenkins, Westminster, CA (US); Andre Hudson, Los Angeles, CA (US)

(73) Assignee: MULLEN TECHNOLOGIES, INC., Brea, CA (US)

(21) Appl. No.: 19/060,593

(22) Filed: Feb. 21, 2025

Related U.S. Application Data
(60) Provisional application No. 63/559,456, filed on Feb. 29, 2024.

(51) Int. Cl. B60R 7/04; B60K 35/53

(52) U.S. Cl. CPC B60R 7/04; B60K 35/53

(57) ABSTRACT

Adjustable storage bins for vehicles and methods for using the same are provided. An adjustable multifunction storage bin may be configured to utilize extra volume (e.g., as may be defined by or otherwise provided from any suitable B-class surface(s) (e.g., of a vehicle) or the like), which may create a variable depth/volume by allowing a user to select a floor height of the bin.

### CROSS REFERENCE TO RELATED APPLICATION(S)

This application claims the benefit of prior filed U.S. Provisional Patent Application No. 63/559,456, filed Feb. 29, 2024, which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to adjustable storage bins and, more particularly, to adjustable storage bins for vehicles and methods for using the same.

### BACKGROUND OF THE DISCLOSURE

Many passenger vehicles have center consoles between adjacent seats. However, such center consoles are often limited in their storage capabilities.

### SUMMARY OF THE DISCLOSURE

This document describes adjustable storage bins for vehicles and methods for using the same.

For example, a system is provided for an adjustable storage bin, as disclosed herein.

As another example, a method is provided for using an adjustable storage bin, as disclosed herein.

As yet another example, there is provided a non-transitory computer-readable storage medium storing at least one program, the at least one program including instructions, which, when executed by at least one processor, cause the at least one processor to use an adjustable storage bin, as disclosed herein.

As yet another example, there is provided a vehicle that includes a vehicle bin component defining a vehicle bin component space, and a storage bin system including a bin carrier defining a carrier space, wherein the bin carrier is at least partially positioned within the vehicle bin component space, a tray, and a tray movement assembly operative to control movement within the carrier space of the tray between a plurality of tray positions relative to the bin carrier.

As yet another example, there is provided a vehicle that includes a vehicle bin component defining a vehicle bin component space, and a storage bin system including a bin carrier defining a carrier space, wherein the bin carrier is at least partially positioned within the vehicle bin component space, a tray, and a tray movement assembly operative to move the tray within the carrier space along a first axis, and move the tray out from the carrier space along a second axis that is perpendicular to the first axis.

As yet another example, there is provided a vehicle including a vehicle bin component defining a vehicle bin component space, and a storage bin system including a bin carrier defining a carrier space, wherein the bin carrier is at least partially positioned within the vehicle bin component space, a tray, and a tray movement assembly operative to control movement within the carrier space along a first axis of the tray between a first tray position and a second tray position, wherein the bin carrier includes a wall with an opening for enabling a user to move the tray along a second axis perpendicular to the first axis from the second tray position to a third tray position external from the carrier space.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system that may provide a vehicle management service in accordance with some embodiments of the disclosure;

FIG. 1A is a more detailed schematic view of a subsystem of the system of FIG. 1, in accordance with some embodiments of the disclosure;

FIG. 1B is a more detailed schematic view of a portion of the system of FIG. 1, in accordance with some embodiments of the disclosure;

FIG. 1C is a more detailed schematic view of another portion of the system of FIG. 1, in accordance with some embodiments of the disclosure;

FIG. 1D is a schematic view of a portion of a system that may provide a vehicle management service in accordance with some embodiments of the disclosure;

FIG. 2 is a top, rear, right side perspective view of a vehicle with an adjustable storage bin system, in accordance with some embodiments of the disclosure;

FIG. 2A is a top, front, left side perspective view of a portion of the vehicle of FIG. 2, in accordance with some embodiments of the disclosure;

FIG. 2B is a rear interior view of a portion of the vehicle of FIGS. 2 and 2A, taken from line IIB-IIB of FIG. 2A, in accordance with some embodiments of the disclosure;

FIG. 2C is a top, rear, left side perspective view of a portion of the vehicle of FIGS. 2, 2A, and 2B, in accordance with some embodiments of the disclosure;

FIG. 2D is a front interior view of a portion of the vehicle of FIGS. 2 and 2A-2C, taken from line IID-IID of FIG. 2A, in accordance with some embodiments of the disclosure;

FIG. 2E is a right side interior view of a portion of the vehicle of FIGS. 2 and 2A-2D, taken from line IIE-IIE of FIG. 2A, in accordance with some embodiments of the disclosure;

FIG. 2F is a rear interior view of a portion of the vehicle of FIGS. 2 and 2A-2E, taken from line IIF-IIF of FIG. 2A, in accordance with some embodiments of the disclosure;

FIG. 2G is a left side interior view of a portion of the vehicle of FIGS. 2 and 2A-2F, taken from line IIG-IIG of FIG. 2A, in accordance with some embodiments of the disclosure;

FIG. 2H is a top view of a portion of the vehicle of FIGS. 2 and 2A-2G, in accordance with some embodiments of the disclosure;

FIG. 2I is a top, rear, right side perspective view of a portion of the vehicle of FIGS. 2 and 2A-2H, in accordance with some embodiments of the disclosure;

FIG. 2J is a top, rear, left side perspective view of a portion of the vehicle of FIGS. 2 and 2A-2I, in accordance with some embodiments of the disclosure;

FIG. 2K is a left side interior view of a portion of the vehicle of FIGS. 2 and 2A-2J, taken from line IIK-IIK of FIG. 2A, in accordance with some embodiments of the disclosure;

FIG. 3 is a top, rear, left side perspective view of an adjustable storage bin system, in accordance with some embodiments of the disclosure;

FIG. 3A is a cross-sectional view of a portion of the adjustable storage bin system of FIG. 3, taken from line IIIA-IIIA of FIG. 3, in accordance with some embodiments of the disclosure;

FIG. 3B is a cross-sectional view of a portion of the adjustable storage bin system of FIGS. 3 and 3A, taken from line IIIB-IIIB of FIG. 3, in accordance with some embodiments of the disclosure;

FIG. 3C is a cross-sectional view of a portion of the adjustable storage bin system of FIGS. 3, 3A, and 3B, taken from line IIIC-IIIC of FIG. 3, in accordance with some embodiments of the disclosure;

FIG. 3D is a cross-sectional view of a portion of the adjustable storage bin system of FIGS. 3 and 3A-3C, taken from line IIID-IIID of FIG. 3, in a first configuration, in accordance with some embodiments of the disclosure;

FIG. 3D′ is a cross-sectional view of a portion of the adjustable storage bin system of FIGS. 3 and 3A-3D, taken from line IIID′-IIID′ of FIG. 3D, in accordance with some embodiments of the disclosure;

FIG. 3E is a cross-sectional view of a portion of the adjustable storage bin system of FIGS. 3 and 3A-3D′, taken from line IIIE-IIIE of FIG. 3, in a second configuration, in accordance with some embodiments of the disclosure;

FIG. 3E′ is a cross-sectional view of a portion of the adjustable storage bin system of FIGS. 3 and 3A-3E, taken from line IIIE′-IIIE′ of FIG. 3E, in accordance with some embodiments of the disclosure;

FIG. 3F is a cross-sectional view of a portion of the adjustable storage bin system of FIGS. 3 and 3A-3E′, taken from line IIIF-IIIF of FIG. 3, in a third configuration, in accordance with some embodiments of the disclosure;

FIG. 3F′ is a cross-sectional view of a portion of the adjustable storage bin system of FIGS. 3 and 3A-3F, taken from line IIIF′-IIIF′ of FIG. 3F, in accordance with some embodiments of the disclosure;

FIG. 3F″ is a cross-sectional view of a portion of the adjustable storage bin system of FIGS. 3 and 3A-3F′, taken from line IIIF″-IIIF″ of FIG. 3, in various configurations, in accordance with some embodiments of the disclosure;

FIG. 3F″ is a cross-sectional view of a portion of the adjustable storage bin system of FIGS. 3 and 3A-3F″, taken from line IIIF′″-IIIF′″ of FIG. 3, in various configurations, in accordance with some embodiments of the disclosure;

FIG. 3G is an exploded top, rear, left side perspective view of the adjustable storage bin system of FIGS. 3 and 3A-3F′″, in accordance with some embodiments of the disclosure;

FIG. 3H is a top, rear, left side perspective view of the adjustable storage bin system of FIGS. 3 and 3A-3G, in accordance with some embodiments of the disclosure;

FIG. 3I is a top view of the adjustable storage bin system of FIGS. 3 and 3A-3H, in accordance with some embodiments of the disclosure;

FIG. 3J is a rear view of the adjustable storage bin system of FIGS. 3 and 3A-3I, in accordance with some embodiments of the disclosure;

FIG. 3K is a left side view of the adjustable storage bin system of FIGS. 3 and 3A-3J, in accordance with some embodiments of the disclosure;

FIG. 3L is a front view of the adjustable storage bin system of FIGS. 3 and 3A-3K, in accordance with some embodiments of the disclosure;

FIG. 3M is a right side view of the adjustable storage bin system of FIGS. 3 and 3A-3L, in accordance with some embodiments of the disclosure;

FIG. 3N is a bottom view of the adjustable storage bin system of FIGS. 3 and 3A-3M, in accordance with some embodiments of the disclosure;

FIG. 4 is a top, rear, left side perspective view of another adjustable storage bin system, in accordance with some embodiments of the disclosure;

FIG. 4A is a top, rear, left side perspective view of a portion of another adjustable storage bin system, in accordance with some embodiments of the disclosure;

FIG. 4′ is another top, rear, left side perspective view of the adjustable storage bin system of FIG. 4, in accordance with some embodiments of the disclosure;

FIG. 4″ is a top, rear, right side perspective view of the adjustable storage bin system of FIG. 4, in accordance with some embodiments of the disclosure;

FIG. 4′ is a top, front, right side perspective view of the adjustable storage bin system of FIG. 4, in accordance with some embodiments of the disclosure;

FIG. 4″ is another top, front, right side perspective view of the adjustable storage bin system of FIG. 4, in accordance with some embodiments of the disclosure;

FIG. 4A′ is a top, front, left side perspective view of the adjustable storage bin system of FIG. 4A, in accordance with some embodiments of the disclosure;

FIG. 4A″ is another top, rear, left side perspective view of the adjustable storage bin system of FIG. 4A, in accordance with some embodiments of the disclosure;

FIG. 4A″ is a top, rear, right side perspective view of the adjustable storage bin system of FIG. 4A, in accordance with some embodiments of the disclosure;

FIG. 4A″″ is another top, rear, right side perspective view of the adjustable storage bin system of FIG. 4A, in accordance with some embodiments of the disclosure;

FIG. 5 is a top, rear, left side perspective view of another adjustable storage bin system, in accordance with some embodiments of the disclosure;

FIG. 5A is an exploded top, rear, left side perspective view of the adjustable storage bin system of FIG. 5, in accordance with some embodiments of the disclosure;

FIG. 5B is a partial cross-sectional view, taken from line VB-VB of FIG. 5, of the adjustable storage bin system of FIGS. 5 and 5A, in a first configuration, in accordance with some embodiments of the disclosure; and

FIG. 5C is a partial cross-sectional view, taken from line VB-VB of FIG. 5, of the adjustable storage bin system of FIGS. 5 and 5A, in a second configuration, in accordance with some embodiments of the disclosure.

### DETAILED DESCRIPTION OF THE DISCLOSURE

Adjustable storage bins for vehicles and methods for using the same are provided.

An objective is to provide extra storage opportunities and flexible areas for storage that conventionally do not include unique functions, thereby allowing users to define storage spaces that may be customized for their needs rather than fixed volume areas. An adjustable multifunction storage bin may be configured to utilize extra volume (e.g., as may be defined by or otherwise provided from any suitable B-class surface(s) (e.g., of a vehicle) or the like), which may create a variable depth/volume by allowing a user to select a floor height of the bin. To accomplish various adjusting mechanisms, this concept may be adapted to any suitable bin designs to provide maximum storage space within an available package space. An adjustable volume storage bin function may be customizable such that a bin may not be limited to storing specific items but may be reconfigurable to allow users to pursue various volume preferences for storing different types of items. Without an adjustable multifunction storage bin, a user may be stuck with a fixed bin provided by a manufacturer. For example, some packaging in in-car entertainment (“ICE”) or other infotainment technologies, such as compact disc player hardware, may sacrifice B-side packaging, thereby limiting the storage areas.

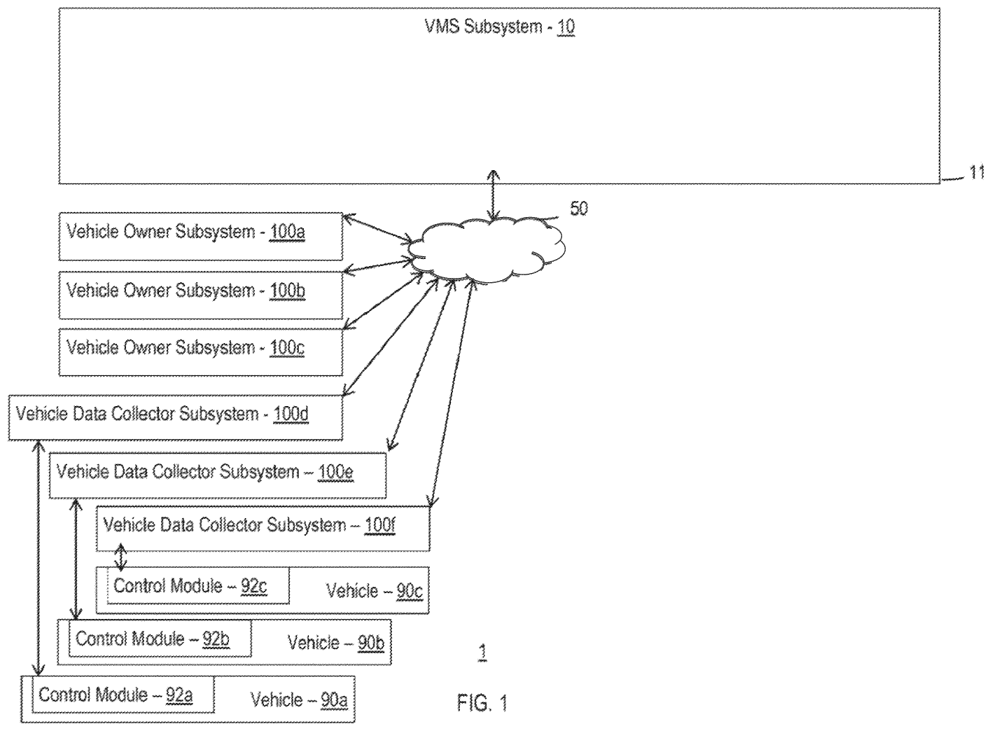

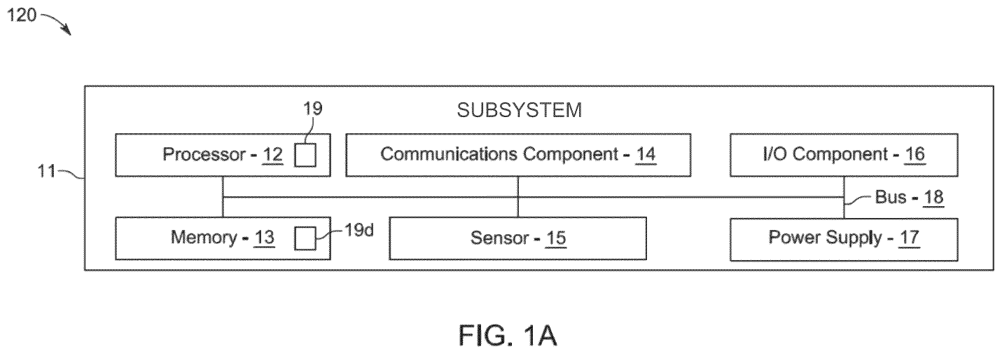

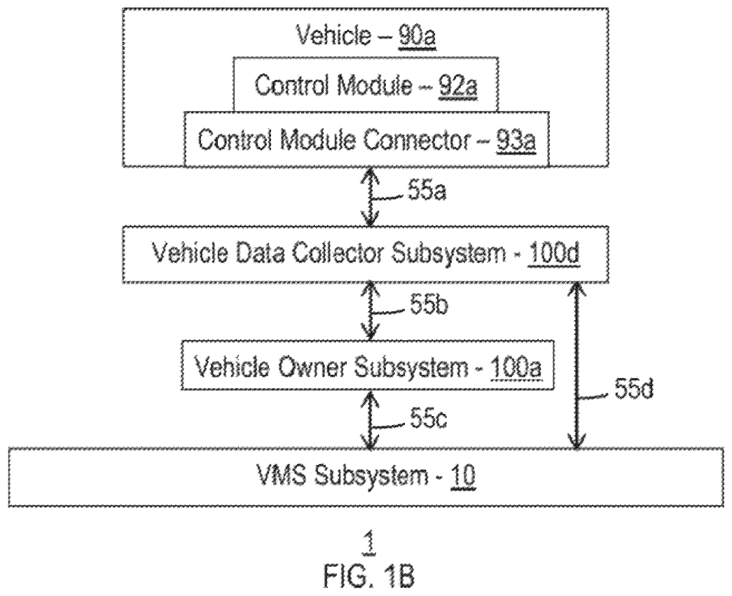

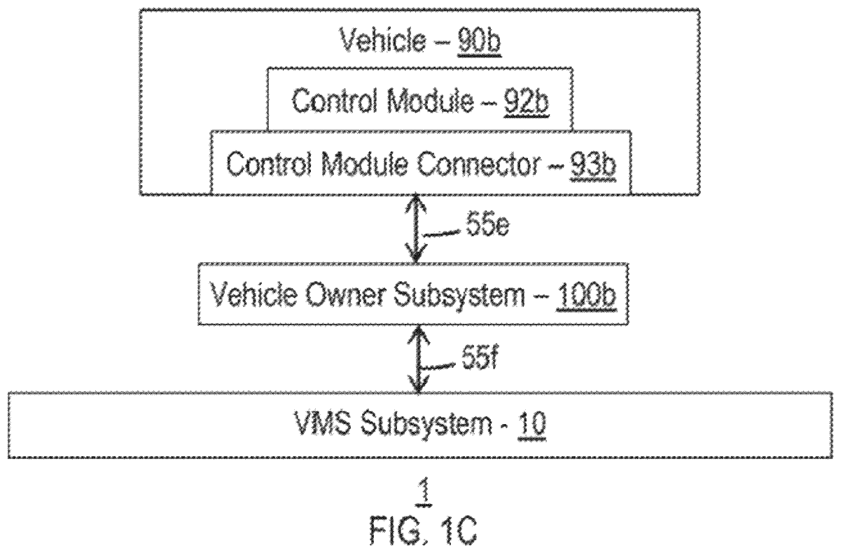

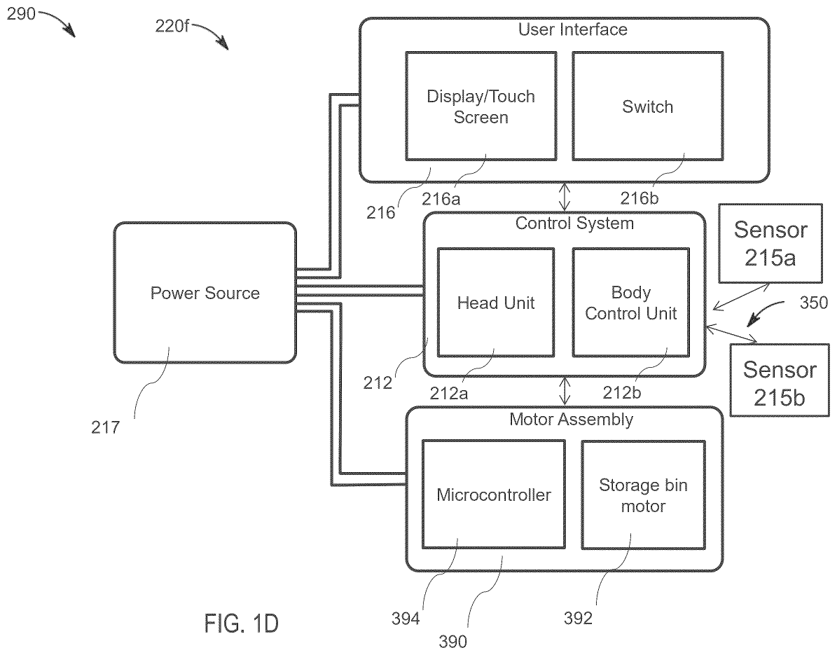

FIG. 1 is a schematic view of an illustrative system 1 in which a vehicle management service, including, but not limited to adjustable multifunction storage bin management, may be facilitated amongst one or more various entities. For example, as shown in FIG. 1, system 1 may include a vehicle management service (“VMS”) subsystem 10, various subsystems 100 (e.g., one or more vehicle owner (“VO”) subsystems 100a-100c, one or more vehicle data collector (“VDC”) subsystems 100d-100f, each of which may be communicatively coupled to one or more control modules (“CMs”) 92 of a respective vehicle 90 (e.g., CMs 92a-92c of respective vehicles 90a-90c that may be owned or operated or managed or controlled by passengers or owners of respective vehicle owner subsystems 100a-100c), and at least one communications network 50 through which any two or more of the subsystems 10 and 100 may communicate. VMS subsystem 10 may be operative to interact with any of the various subsystems 100 to provide a vehicle management service platform (“VMSP”) that may facilitate various vehicle management services, including, but not limited to, managing and enhancing the vehicle ownership process for vehicle buyers, vehicle users, and vehicle sellers for enabling effective and efficient vehicle transactions.

As shown in FIG. 1A, and as described in more detail below, a subsystem 120, which may be any of subsystems 10, 100, and/or modules 92, may include a processor component 12, a memory component 13, a communications component 14, a sensor component 15, an input/output (“I/O”) component 16, a power supply component 17, and/or a bus 18 that may provide one or more wired or wireless communication links or paths for transferring data and/or power to, from, or between various other components of subsystem 120. In some embodiments, one or more components of subsystem 120 may be combined or omitted. Moreover, subsystem 120 may include other components not combined or included in FIG. 1A and/or several instances of the components shown in FIG. 1A. For the sake of simplicity, only one of each of the components of subsystem 120 is shown in FIG. 1A. I/O component 16 may include at least one input component (e.g., button, mouse, keyboard, etc.) to receive information from a user or other device or power therefrom and/or at least one output component (e.g., audio speaker, video display, haptic component, etc.) to provide information or power or any other suitable support to a user or other device, such as a touch screen that may receive input information through a user's touch of a display screen and that may also provide visual information to a user via that same display screen, or an airbag that may be deployed to provide security to one or more passengers of a vehicle user, or an adjustable multifunction storage bin, and/or the like. In some embodiments, an I/O component 16 may be any suitable data and/or power connector (e.g., a Universal Serial Bus (“USB”) connector or any other suitable connector type, a wireless charger (e.g., an inductive charging pad or the like), etc.) that may be utilized in any suitable manner by any suitable portable media device or the like. Memory 13 may include one or more storage mediums or media, including for example, a hard-drive, flash memory, permanent memory such as read-only memory (“ROM”), semi-permanent memory such as random access memory (“RAM”), any other suitable type of storage component, or any combination thereof (e.g., for storing any suitable data (e.g., data 19d)). Communications component 14 may be provided to allow subsystem 120 to communicate with one or more other subsystems 120 (e.g., any communication to/from/between subsystem(s)/module(s) 10, 100, and 92 of system 1) using any suitable communications protocol. Communications component 14 can be operative to create or connect to a communication network or link of a network. Communications component 14 can provide wireless communications using any suitable short-range or long-range communications protocol, such as Wi-Fi (e.g., an 802.11 protocol), Bluetooth, ultra-wideband, radio frequency systems (e.g., 1200 MHz, 2.4 GHz, and 5.6 GHz communication systems), near field communication (“NFC”), infrared, protocols used by wireless and cellular telephones and personal e-mail devices, or any other protocol supporting wireless communications. Communications component 14 can also be operative to connect to a wired communications link or directly to another data source wirelessly or via one or more wired connections or other suitable connection type(s). Communications component 14 may be a network interface that may include the mechanical, electrical, and/or signaling circuitry for communicating data over physical links that may be coupled to other devices of a network. Such network interface(s) may be configured to transmit and/or receive any suitable data using a variety of different communication protocols, including, but not limited to, TCP/IP, UDP, ATM, synchronous optical networks (“SONET”), any suitable wired protocols or wireless protocols now known or to be discovered, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access.

Sensor 15 may be any suitable sensor that may be configured to sense any suitable data for subsystem 120 (e.g., location-based data via a GPS sensor system, motion data, environmental data, biometric data, etc.). Sensor 15 may be a sensor assembly that may include any suitable sensor or any suitable combination of sensors operative to detect movements of subsystem 120 and/or of any user thereof and/or any other characteristics of subsystem 120 and/or of its environment (e.g., physical activity or other characteristics of a user of subsystem 120, light content of the device environment, gas pollution content of the device environment, noise pollution content of the device environment, altitude of the device, etc.). Sensor 15 may include any suitable sensor(s), including, but not limited to, one or more of a GPS sensor, wireless communication sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. Sensor 15 may include any suitable sensor components or subassemblies for detecting any suitable movement of subsystem 120 and/or of a user thereof. For example, sensor 15 may include one or more three-axis acceleration motion sensors (e.g., an accelerometer) that may be operative to detect linear acceleration in three directions (i.e., the x- or left/right direction, the y- or up/down direction, and the z- or forward/backward direction). As another example, sensor 15 may include one or more single-axis or two-axis acceleration motion sensors that may be operative to detect linear acceleration only along each of the x- or left/right direction and the y- or up/down direction, or along any other pair of directions. In some embodiments, sensor 15 may include an electrostatic capacitance (e.g., capacitance-coupling) accelerometer that may be based on silicon micro-machined micro electro-mechanical systems (“MEMS”) technology, including a heat-based MEMS type accelerometer, a piezoelectric type accelerometer, a piezo-resistance type accelerometer, and/or any other suitable accelerometer (e.g., which may provide a pedometer or other suitable function). Sensor 15 may be operative to directly or indirectly detect rotation, rotational movement, angular displacement, tilt, position, orientation, motion along a non-linear (e.g., arcuate) path, or any other non-linear motions. Additionally or alternatively, sensor 15 may include one or more angular rate, inertial, and/or gyro-motion sensors or gyroscopes for detecting rotational movement. For example, sensor 15 may include one or more rotating or vibrating elements, optical gyroscopes, vibrating gyroscopes, gas rate gyroscopes, ring gyroscopes, magnetometers (e.g., scalar or vector magnetometers), compasses, and/or the like. Any other suitable sensors may also or alternatively be provided by sensor 15 for detecting motion on subsystem 120, such as any suitable pressure sensors, altimeters, or the like. Using sensor 15, subsystem 120 may be configured to determine a velocity, acceleration, orientation, and/or any other suitable motion attribute of subsystem 120 (e.g., a direction and/or strength of an impact (e.g., a crash involving a vehicle 90). One or more biometric sensors may be multi-modal biometric sensors and/or operative to detect long-lived biometrics, modern liveness (e.g., active, passive, etc.) biometric detection, and/or the like. Sensor 15 may include a microphone, camera, scanner (e.g., a barcode scanner or any other suitable scanner that may obtain product identifying information from a code, such as a linear barcode, a matrix barcode (e.g., a quick response (“QR”) code), or the like), proximity sensor, light detector, temperature sensor, motion sensor, biometric sensor (e.g., a fingerprint reader or other feature (e.g., facial) recognition sensor, which may operate in conjunction with a feature-processing application that may be accessible to subsystem 120 for attempting to authenticate a user), line-in connector for data and/or power, and/or combinations thereof. In some examples, each sensor can be a separate device, while, in other examples, any combination of two or more of the sensors can be included within a single subsystem or device. For example, a gyroscope, accelerometer, photoplethysmogram, galvanic skin response sensor, and temperature sensor can be included within a wearable electronic device, such as a smart watch, while a scale, blood pressure cuff, blood glucose monitor, SpO2 sensor, respiration sensor, posture sensor, stress sensor, and asthma inhaler can each be separate devices. While specific examples are provided, it should be appreciated that other sensors can be used and other combinations of sensors can be combined into a single subsystem or device. Subsystem 120 can further include a timer that can be used, for example, to add time dimensions to various attributes of any detected element(s). Sensor 15 may include any suitable sensor components or subassemblies for detecting any suitable characteristics of any suitable condition of the lighting of the environment of subsystem 120. For example, sensor 15 may include any suitable light sensor that may include, but is not limited to, one or more ambient visible light color sensors, illuminance ambient light level sensors, ultraviolet (“UV”) index and/or UV radiation ambient light sensors, and/or the like. Any suitable light sensor or combination of light sensors may be provided for determining the illuminance or light level of ambient light in the environment of subsystem 120 (e.g., in lux or lumens per square meter, etc.) and/or for determining the ambient color or white point chromaticity of ambient light in the environment of subsystem 120 (e.g., in hue and colorfulness or in x/y parameters with respect to an x-y chromaticity space, etc.) and/or for determining the UV index or UV radiation in the environment of subsystem 120 (e.g., in UV index units, etc.). Sensor 15 may include any suitable sensor components or subassemblies for detecting any suitable characteristics of any suitable condition of the air quality of the environment of subsystem 120. For example, sensor 15 may include any suitable air quality sensor that may include, but is not limited to, one or more ambient air flow or air velocity meters, ambient oxygen level sensors, volatile organic compound (“VOC”) sensors, ambient humidity sensors, ambient temperature sensors, and/or the like. Any suitable ambient air sensor or combination of ambient air sensors may be provided for determining the oxygen level of the ambient air in the environment of subsystem 120 (e.g., in O₂% per liter, etc.) and/or for determining the air velocity of the ambient air in the environment of subsystem 120 (e.g., in kilograms per second, etc.) and/or for determining the level of any suitable harmful gas or potentially harmful substance (e.g., VOC (e.g., any suitable harmful gasses, scents, odors, etc.) or particulate or dust or pollen or mold or the like) of the ambient air in the environment of subsystem 120 (e.g., in HG % per liter, etc.) and/or for determining the humidity of the ambient air in the environment of subsystem 120 (e.g., in grams of water per cubic meter, etc. (e.g., using a hygrometer)) and/or for determining the temperature of the ambient air in the environment of subsystem 120 (e.g., in degrees Celsius, etc. (e.g., using a thermometer)). Sensor 15 may include any suitable sensor components or subassemblies for detecting any suitable characteristics of any suitable condition of the sound quality of the environment of subsystem 120. For example, sensor 15 may include any suitable sound quality sensor that may include, but is not limited to, one or more microphones or the like that may determine the level of sound pollution or noise in the environment of subsystem 120 (e.g., in decibels, etc.). Sensor 15 may also include any other suitable sensor for determining any other suitable characteristics about a user of subsystem 120 and/or the environment of subsystem 120 and/or any situation within which subsystem 120 may exist. For example, any suitable clock and/or position sensor(s) may be provided to determine the current time and/or time zone within which subsystem 120 may be located. Sensor 15 may be embedded in a body (e.g., housing 11) of subsystem 120, such as along a bottom surface that may be operative to contact a user, or can be positioned at any other desirable location. In some examples, different sensors can be placed in different locations inside or on the surfaces of subsystem 120 (e.g., some located inside housing 11 (e.g., any suitable component of a vehicle) and some attached to an attachment mechanism (e.g., a wrist band coupled to a housing of a wearable device), or the like). In other examples, one or more sensors can be worn by a user separately as different parts of a single subsystem 120 or as different subsystems or devices. In such cases, the sensors can be configured to communicate with subsystem 120 using a wired and/or wireless technology (e.g., via communications component 14). In some examples, sensors can be configured to communicate with each other and/or share data collected from one or more sensors.

Power supply 17 can include any suitable circuitry for receiving and/or generating power, and for providing such power to one or more of the other components of subsystem 120. For example, power supply assembly 17 can be coupled to a power grid (e.g., when subsystem 120 is not acting as a portable device or when a battery of the device is being charged at an electrical outlet with power generated by an electrical power plant). As another example, power supply assembly 17 may be configured to generate power from a natural source (e.g., solar power using solar cells). As another example, power supply assembly 17 can include one or more batteries for providing power (e.g., when subsystem 120 is acting as a portable device). Subsystem 120 may also be provided with a housing 11 that may at least partially enclose one or more of the components of subsystem 120 for protection from debris and other degrading forces external to subsystem 120. Each component of subsystem 120 may be included in the same housing 11 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, subsystem 120 may include other components not combined or included in those shown or several instances of the components shown.

Processor 12 may be used to run one or more applications, such as an application 19 that may be accessible from memory 13 (e.g., as a portion of data 19d) and/or any other suitable source (e.g., from any other device in its system). Application 19 may include, but is not limited to, one or more operating system applications, firmware applications, communication applications (e.g., for enabling communication of data between devices), third party service applications, internet browsing applications (e.g., for interacting with a website provided by a third party subsystem), application programming interfaces (“APIs”), software development kits (“SDKs”), proprietary applications (e.g., a web application or a native application) for enabling subsystem 120 to interact with an online service and/or one or more other subsystems and/or the like, which may include applications for routing protocols, SDN modules based on OpenFlow, P4, or other network data plane programming standards, machine learning algorithms, network management functions, etc., any other suitable applications, such as applications for detecting and reacting to impact on a vehicle and/or detecting and reacting to positioning of travelers and components (e.g., seats, sun roof, etc.) of and within a vehicle (e.g., to adjust the position of any vehicle feature (e.g., sunroof or seat or passenger or adjustable multifunction storage bin) and/or deploy an airbag or the like), applications for detecting and reacting to communicative coupling to/decoupling from any suitable portable media device, and/or the like. For example, processor 12 may load an application 19 as an interface program to determine how instructions or data received via an input component of I/O component 16 or other component of subsystem 120 (e.g., sensor 15 and/or communications component 14) may manipulate the way in which information may be stored (e.g., in memory 13) and/or provided via an output component of I/O component 16 and/or communicated to another system device via communications component 14. As one example, application 19 may be a third party application that may be running on subsystem 120 (e.g., an application associated with the network of system 1) that may be loaded on subsystem 120 in any suitable manner, such as via an application market (e.g., using communications component 14), such as the Apple App Store or Google Play, or that may be accessed via an internet application or web browser (e.g., by Apple Safari or Google Chrome) that may be running on subsystem 120 and that may be pointed to a uniform resource locator (“URL”) whose target or web resource may be managed by or otherwise affiliated with any suitable entity. Any subsystem may include any suitable special purpose hardware (e.g., hardware support of high-speed packet processing, hardware support of machine learning algorithms, etc.).

Subsystem 120 may be any portable, mobile, wearable, implantable, or hand-held electronic device configured to operate with system 1. Alternatively, subsystem 120 may not be portable during use, but may instead be generally stationary (e.g., permanently coupled to a vehicle). Subsystem 120 can include, but is not limited to, a media player, video player, still image player, game player, other media player, music recorder, movie or video camera or recorder, still camera, other media recorder, radio, medical equipment, domestic appliance, smart appliance (e.g., smart door knob, smart door lock, etc.), transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device, boom box, modem, router, printer, kiosk, beacon, server, adjustable multifunction storage bin, and any combinations thereof.

In some embodiments, processor 12 may be used to run one or more applications that may be accessible from memory 13 and/or from any other suitable source (e.g., an application from VMS subsystem 10 via an active internet connection or otherwise at and for use by a subsystem 100). Such an application may include, but is not limited to, one or more operating system applications, firmware applications, communication applications, internet browsing applications (e.g., for interacting with a website provided by VMS subsystem 10 for enabling a subsystem 100 to interact with an online service of VMS subsystem 10 (e.g., a VMSP)), VMS applications (e.g., a web application or a native application or a hybrid application that may be at least partially produced by VMS subsystem 10 for enabling a subsystem 100 to interact with an online service of VMS subsystem 10 (e.g., a VMSP)), or any other suitable applications. As one example, an application of a subsystem 100 may provide a user or a communicatively coupled device (e.g., control module 92) with the ability to interact with a vehicle management service or the VMSP of VMS subsystem 10, where such an application may be a third party application that may be running on a subsystem 100 (e.g., an application (e.g., software and/or firmware) associated with VMS subsystem 10 that may be loaded on subsystem 100 from VMS subsystem 10 or via an application market) and/or that may be accessed via an internet application or web browser running on subsystem 100 (e.g., processor 12) that may be pointed to a uniform resource locator (“URL”) whose target or web resource may be managed by VMS subsystem 10 or any other remote subsystem. Each subsystem 100 may be a portable media device (e.g., a smartphone), a laptop computer, a tablet computer, a desktop computer, an appliance, a wearable electronic device, a virtual reality device, a dongle device, at least one web or network server (e.g., for providing an online resource, such as a website or native online application, for presentation on one or more other subsystems) with an interface for an administrator of such a server, and/or the like.

Some or all portions of VMS subsystem 10 may be operated, managed, or otherwise at least partially controlled by an entity (e.g., administrator) responsible for providing a vehicle management service to one or more clients or other suitable entities. VMS subsystem 10 may communicate with one or more subsystems 100 via communications network 50. Network 50 may be the internet or any other suitable network, such that when intercoupled via network 50, any two subsystems of system 1 may be operative to communicate with one another (e.g., a subsystem 100 may access information (e.g., from an application 19 or data 19d of VMS subsystem 10, as may be provided as a vehicle management service via processor 12 and communications component 14 of VMS subsystem 10) as if such information were stored locally at that subsystem 100 (e.g., in its memory component 13)).

Various clients and/or partners may be enabled to interact with VMS subsystem 10 for enabling the vehicle management services and the VMSP. For example, at least one vehicle owner subsystem of system 1 (e.g., each one of the one or more vehicle owner subsystems 100a-100c) may be any suitable subsystem (e.g., portable computer) operated by any suitable vehicle owner (“VO”) that may own, rent, or otherwise have access to a vehicle (e.g., a respective one of the one or more vehicles 90a-90c (e.g., any suitable motor vehicle (e.g., car, truck, bus, motorcycle, etc. (e.g., a road vehicle)), railed vehicle (e.g., train, tram, etc.), watercraft (e.g., ship, boat, jet ski, etc.), aircraft (e.g., airplane, helicopter, drone, etc.), spacecraft, and/or the like)). At least one vehicle data collector subsystem of system 1 (e.g., each one of the one or more vehicle data collector subsystems 100d-100f) may be any suitable subsystem (e.g., dongle device) that may be communicatively coupled to a respective vehicle owner subsystem (e.g., via a network 50) and to a respective control module (e.g., via direct installation) of a respective vehicle (e.g., VDC subsystem 100d may be communicatively coupled to VO subsystem 100a and to CM 92a of vehicle 90a that may be owned by the operator of VO subsystem 100a, VDC subsystem 100e may be communicatively coupled to VO subsystem 100b and to CM 92b of vehicle 90b that may be owned by the operator of VO subsystem 100b, and VDC subsystem 100f may be communicatively coupled to VO subsystem 100c and to CM 92c of vehicle 90c that may be owned by the operator of VO subsystem 100c). For example, a VDC subsystem may be any suitable on-board diagnostics (“OBD”) device that may be operative to be communicatively coupled with any suitable control module of any suitable vehicle (e.g., via any suitable OBD-II data link connector of a vehicle (e.g., via a physical connection or wireless path)) that may be operative to monitor any suitable data from an engine control unit and/or electronic control unit (“ECU”) of the vehicle and/or from any other data source of the vehicle that may be made available (e.g., according to the OBD protocol), such as a powertrain control module (“PCM”) or otherwise. A VDC subsystem may be operative to send one or more requests to the CM of a vehicle for one or more specific parameters using one or more specific parameter identification numbers (“PIDs”) (e.g., according to the Society of Automotive Engineers (“SAE”) standard J1979) and then the VDC subsystem may communicate any received parameter data from the vehicle to a VO subsystem that may be communicatively coupled to the VDC subsystem (e.g., via any suitable wired or wireless communication protocol). For example, as shown in FIG. 1B, VDC subsystem 100d may be communicatively coupled to any suitable control module connector 93a via any suitable communications path 55a, which may be a direct physical connection between connector 93a and a connector of VDC subsystem 100d (e.g., a male connector of an I/O component 16 of VDC subsystem 100d may physically mate with a female control module connector 93a (e.g., any suitable OBD-II data link connector)), where control module connector 93a may be communicatively coupled to one, some, or all suitable control modules or data sources (e.g., control module 92a) of vehicle 90a, while VDC subsystem 100d may be communicatively coupled to VO subsystem 100a via any suitable communications path 55b (e.g., any suitable wired or wireless communications path using any suitable communications protocol (e.g., Bluetooth between a communications component 14 of VDC subsystem 100d and a communications component 14 of VO subsystem 100a), while VO subsystem 100a may be communicatively coupled to VMS subsystem 10 via any suitable communications path 55c (e.g., any suitable wired or wireless communications path (e.g., of network 50 of FIG. 1) using any suitable communications protocol). Alternatively or additionally, as shown in FIG. 1B, VDC subsystem 100d may be communicatively coupled to VMS subsystem 10 via any suitable communications path 55d (e.g., any suitable wired or wireless communications path (e.g., of network 50 of FIG. 1) using any suitable communications protocol (e.g., any suitable long-range communications protocol between a communications component 14 of VDC subsystem 100d and a communications component 14 of VMS subsystem 10 (e.g., using a low power communications component and/or any suitable telemetry functionality)) without VO subsystem 100a as an intermediary. Additionally or alternatively, in some embodiments, a VO subsystem may be configured to communicate directly with a CM of a vehicle without the need for a distinct intermediary VDC subsystem. For example, as shown in FIG. 1C, VO subsystem 100b may be communicatively coupled to any suitable control module connector 93b via any suitable communications path 55e, which may be a direct wired connection between connector 93b and a connector of VO subsystem 100b (e.g., a connector of an I/O component 116 of VO subsystem 100b may be communicatively coupled to a first connector of a cable of communications path 55e and a second connector of such a cable may be communicatively coupled with control module connector 93b (e.g., any suitable OBD-II data link connector)), where control module connector 93b may be communicatively coupled to one, some, or all suitable control modules or data sources (e.g., control module 92b) of vehicle 90b, while VO subsystem 100b may be communicatively coupled to VMS subsystem 10 via any suitable communications path 55f (e.g., any suitable wired or wireless communications path (e.g., of network 50 of FIG. 1) using any suitable communications protocol). In some embodiments, communications path 55e may be a wireless communications path between control module 92b and VO subsystem 100b (e.g., a wireless (e.g., Bluetooth) communication path between a communications component 14 of VO subsystem 100b and a communications component of control module 92b of vehicle 90b), such that a data connection may be facilitated directly between a user's portable electronic device and a computer of a vehicle directly through a wireless connection.

Each subsystem 100 of system 1 (e.g., each one of subsystems 100a-100f) may be operated by any suitable entity for interacting in any suitable way with VMS subsystem 10 (e.g., via network 50) for deriving value from and/or adding value to a service of the VMSP of VMS subsystem 10. For example, a particular subsystem 100 may be a server operated by a client/partner entity that may receive any suitable data from VMS subsystem 10 related to any suitable vehicle management enhancement of the VMSP provided by VMS subsystem 10 (e.g., via network 50). Additionally or alternatively, a particular subsystem 100 may be a server operated by a client/partner entity that may upload or otherwise provide any suitable data to VMS subsystem 10 related to any suitable vehicle management service of the VMSP provided by VMS subsystem 10 (e.g., via network 50).

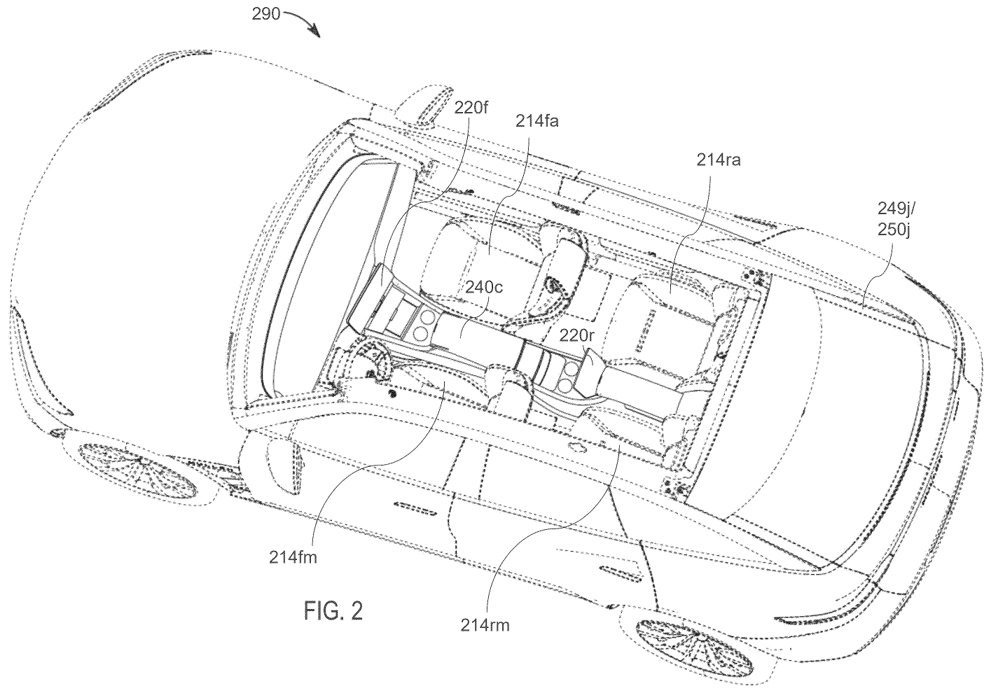

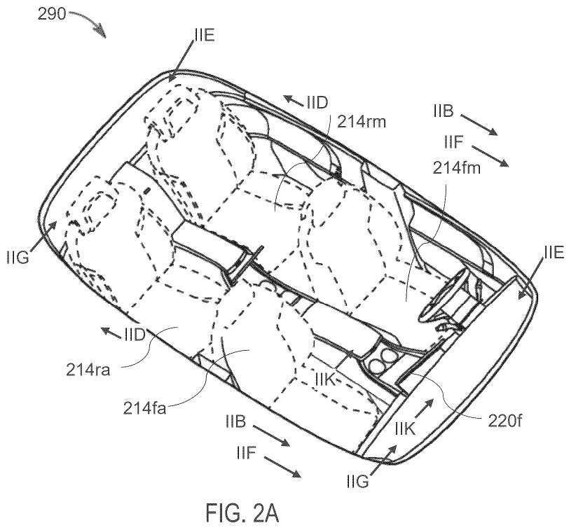

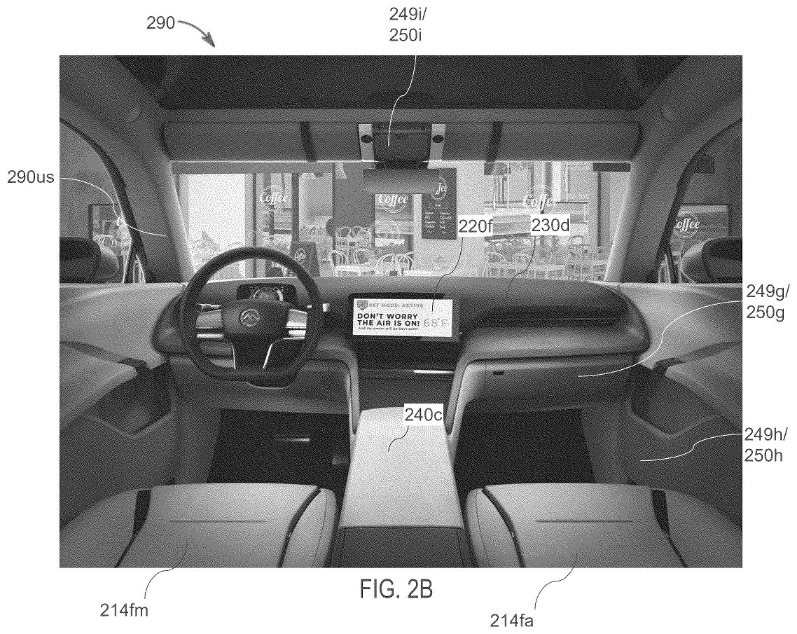

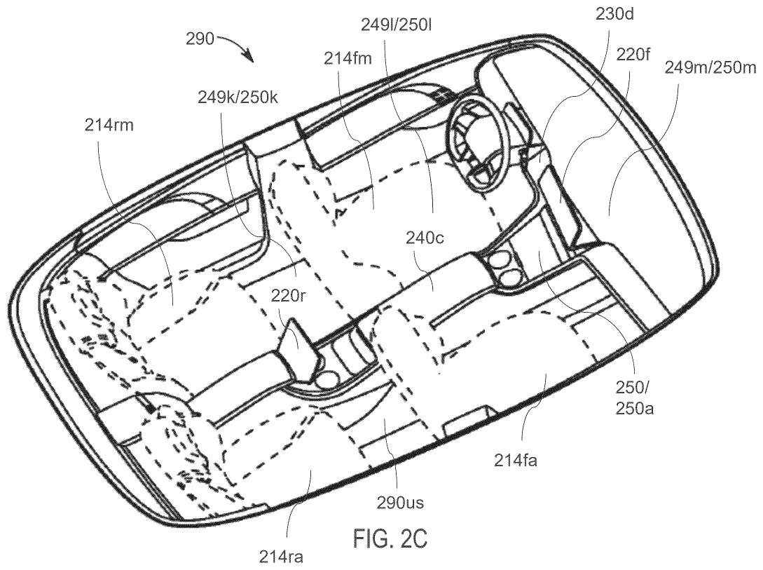

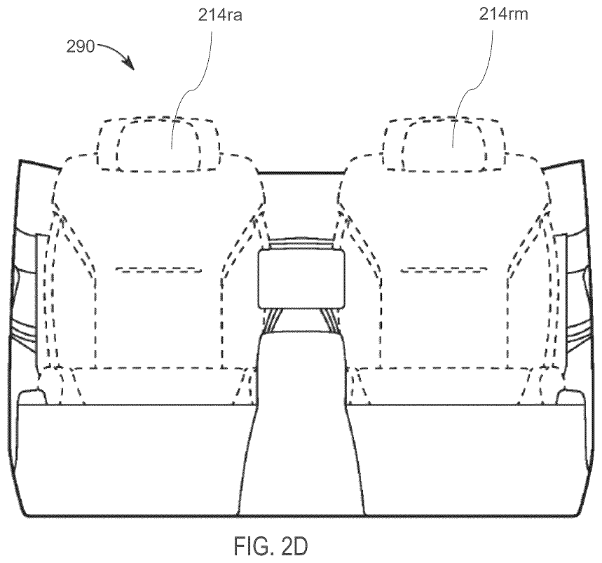

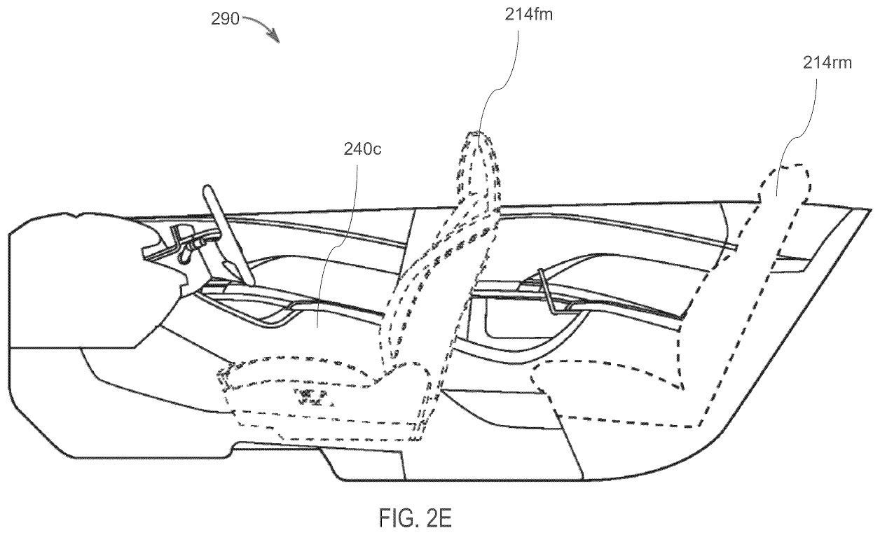

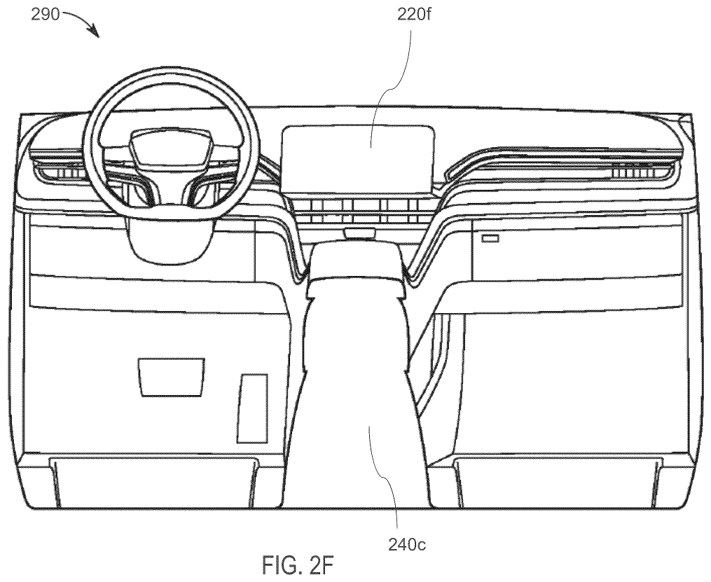

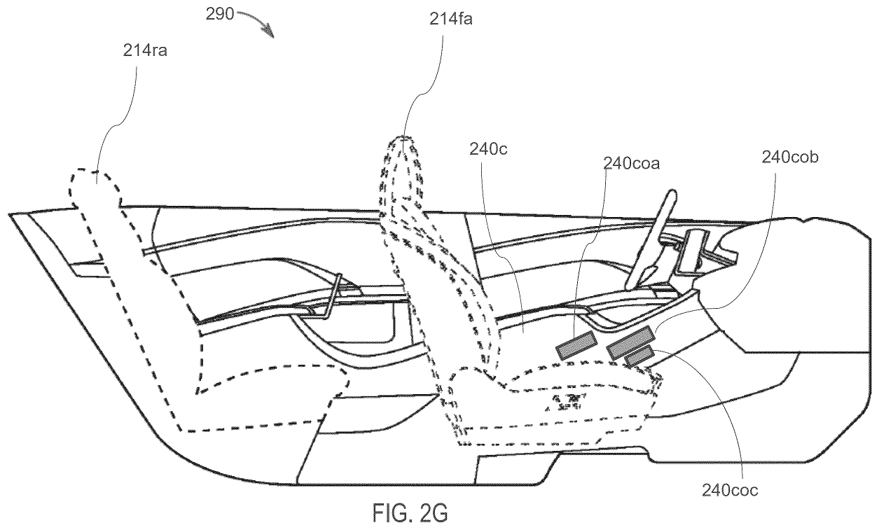

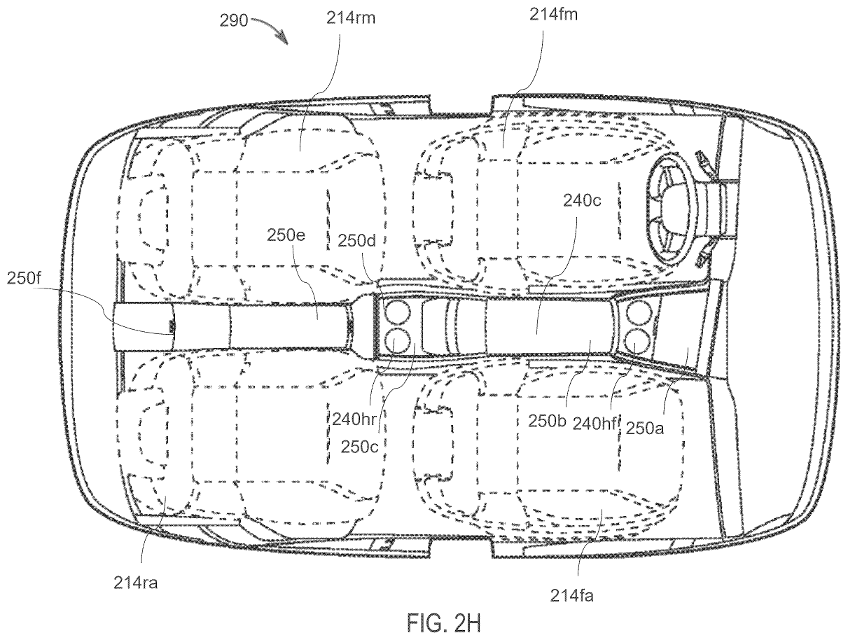

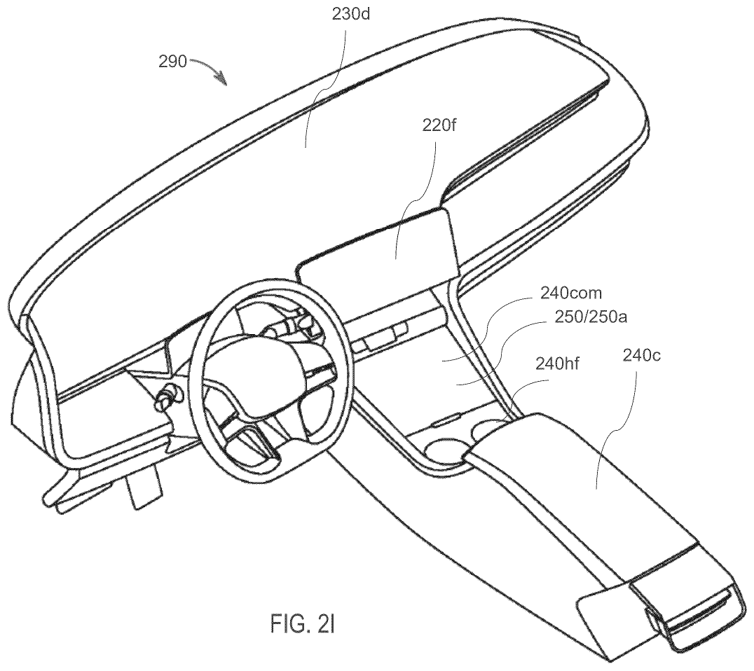

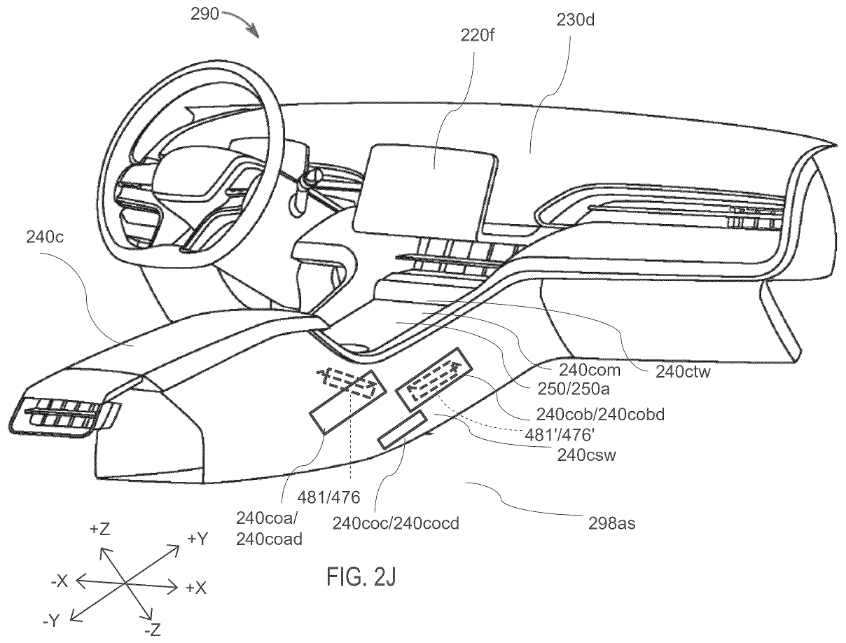

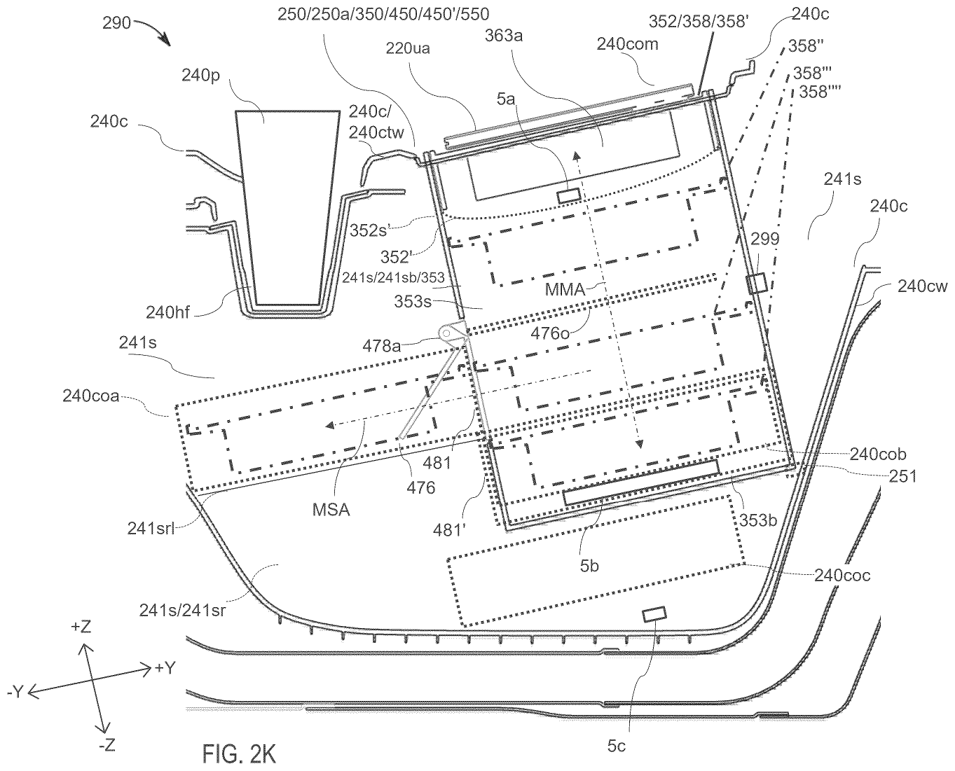

FIGS. 2 and 2A-2K show an illustrative vehicle 290 that may include at least one adjustable storage bin system 250, in accordance with some embodiments of the disclosure. Vehicle 290 may be any suitable vehicle, which may be similar to any vehicle 90 (e.g., vehicles 90a-90c) described herein. As shown, in some embodiments, vehicle 290 may be any suitable automobile with at least one seat, which may include at least a front main seat 214fm (e.g., a driver seat if the vehicle is able to be driven) for a front main passenger (not shown). Additionally, in some embodiments, as shown, vehicle 290 may also include a front auxiliary seat 214fa for a front auxiliary passenger (not shown), and at least one rear seat for one or more rear passengers, such as a rear main seat 214rm for a rear main passenger (not shown) and/or a rear auxiliary seat 214ra for a rear auxiliary passenger (not shown). Although each seat for each passenger may be distinct in one or more ways from one another (see, e.g., distinct seats 214rm and 214ra of FIGS. 2 and 2A), any vehicle may be provided with a single seat that may be used simultaneously by two or more adjacent passengers (e.g., a bench type rear seat). As also shown, vehicle 290 may include at least one vehicle subsystem 220f (e.g., electronic vehicle subsystem) similar to any subsystem 120 that may provide a screen user interface for providing any suitable information to one or more passengers of the vehicle (e.g., a screen that may be permanently coupled to vehicle 290 (e.g., to a dashboard 230d or otherwise), such as an infotainment screen, which may be facing or otherwise accessible not only to any passenger(s) of front seat(s) 214fm and/or 214fa but also to any passenger(s) of rear seat(s) 214rm and/or 214ra). Additionally or alternatively, vehicle may include a rear vehicle subsystem 220r similar to any subsystem 120 that may provide a screen user interface for providing any suitable information to one or more passengers of the vehicle (e.g., a screen that may be permanently coupled to vehicle 290 (e.g., to a rear portion of a console 240c (e.g., a floor console, a center floor console, a center console, a storage console, a first row console, a front console, etc.) or otherwise), such as an infotainment screen, which may be facing or otherwise accessible to passenger(s) of rear seat(s) 214rm and/or 214ra).

An adjustable storage bin system may be incorporated into or otherwise provided by or coupled to any suitable portion of any suitable vehicle. For example, as shown, adjustable storage bin system 250 may be incorporated into or otherwise provided by or coupled to console 240c, which may extend rearward from dashboard 230d and between at least a portion of front seats 214fm and/or 214fa and/or between at least a portion of rear seats 214rm and/or 214ra. As shown, console 240c may include one or more cup holders, such as a front set of cup holders 240hf (e.g., with a cup 240p (see, e.g., FIG. 2K)) and/or a rear set of cup holders 240hr. Additionally or alternatively, as shown, one or more vehicle subsystems, such as subsystem 220f and/or subsystem 220r may be coupled to and/or extend from console 240c. As a particular example, as shown, adjustable storage bin system 250 (e.g., adjustable storage bin system 250a) may be positioned along console 240c just in front of front set of cupholders 240hf and just rear of dashboard 230d. Although, in other embodiments, an adjustable storage bin system 250b may be positioned along console 240c just rear of front set of cupholders 240hf (e.g., for use by front passenger(s)) and/or an adjustable storage bin system 250c may be positioned along console 240c just in front of rear set of cupholders 240hr and/or an adjustable storage bin system 250d may be positioned along console 240c just rear of rear set of cupholders 240hr and/or an adjustable storage bin system 250e may be positioned along console 240c just rear of rear vehicle subsystem 220r and/or an adjustable storage bin system 250f may be positioned along a rear portion console 240c (e.g., for use by rear passenger(s) (e.g., a rear center console or second row console, etc.)). An adjustable storage bin system may be positioned in any other suitable location or in any other suitable vehicle bin component in addition to or as an alternative to a center console (e.g., console 240c), including, but not limited to, a glove box bin or interior storage bin (e.g., a bin 250g at a glove box 249g of vehicle 290), a door trim bin (e.g., a bin 250h at a door trim portion 249h of any suitable door of vehicle 290), an overhead storage bin (e.g., a bin 250i at an overhead portion 249i of any suitable roof of vehicle 290), a trunk trim quarter garnish bin (e.g., a bin 250j at any suitable trunk trim garnish 249j (e.g., quarter garnish) of any suitable trunk portion of vehicle 290), a floor panel bin (e.g., a bin 250k at any suitable floor panel portion 249k of any suitable floor portion (e.g., in front of any suitable seat) of vehicle 290), a seat bin (e.g., a bin 250l at any suitable seat portion 249l of any suitable seat of vehicle 290), an upper panel or an instrument panel storage bin (e.g., a bin 250m at any suitable upper panel or instrument panel 249m of vehicle 290), and/or the like (e.g., any space with enough depth to adequately support a bin may be used). A vehicle bin component that may host an adjustable storage bin system may be positioned within a passenger host space 290us in which one or more passengers may be located during use of vehicle 290 (e.g., passenger host space 290us may be defined by the interior of the floor, ceiling, doors, pillars, windows, and/or the like of the vehicle, while the vehicle bin component may be accessible to a passenger within host space 290us for utilizing an adjustable storage bin system positioned withing that vehicle bin component (e.g., a console bin, glove box bin, door trim bin, overhead storage bin, floor panel bin, seat bin, upper panel bin, etc.)). In other embodiments, a vehicle bin component that may host an adjustable storage bin system may be positioned outside of passenger host space 290us, whereby the vehicle bin component may not be accessible to a passenger within host space 290us, such that the passenger may access the adjustable storage bin system when outside host space 290us (e.g., a trunk trim garnish bin or front hood trim garnish bin).

As shown in FIGS. 2I-2K, console 240c may include one or more openings 240co for providing access to storage bin 250 (e.g., storage bin 250a) that may be positioned within a vehicle bin component space or console space 241s that may be defined by interior surface(s) of any suitable vehicle bin component walls 240cw or other portions of console 240c or of any other suitable vehicle bin component (e.g., glove box bin, door trim bin, overhead storage bin, trunk trim garnish bin, floor panel bin, seat bin, upper panel bin, etc.) of vehicle 290 (e.g., vehicle host space of a vehicle host component). For example, storage bin 250 may be positioned within space 241s to take up a bin space portion 241sb of console space 241s while a remaining space portion 241sr of console space 241s may be used for other purposes, while a first console opening 240com may be provided through a top wall 240ctw of console 240c for exposing a top portion of bin 250, and console openings 240coa, 240cob, and 240coc may be provided through different portions of a side wall 240csw of console 240c for providing access to other portions of bin 250 and/or space 241s. Bin 250 may be coupled (e.g., permanently or removably (e.g., such that an end user may replace, etc.)) to vehicle 290 (e.g., within console space 241s) using any suitable coupling features 251 (e.g., snap features, clip features, track features, etc.).

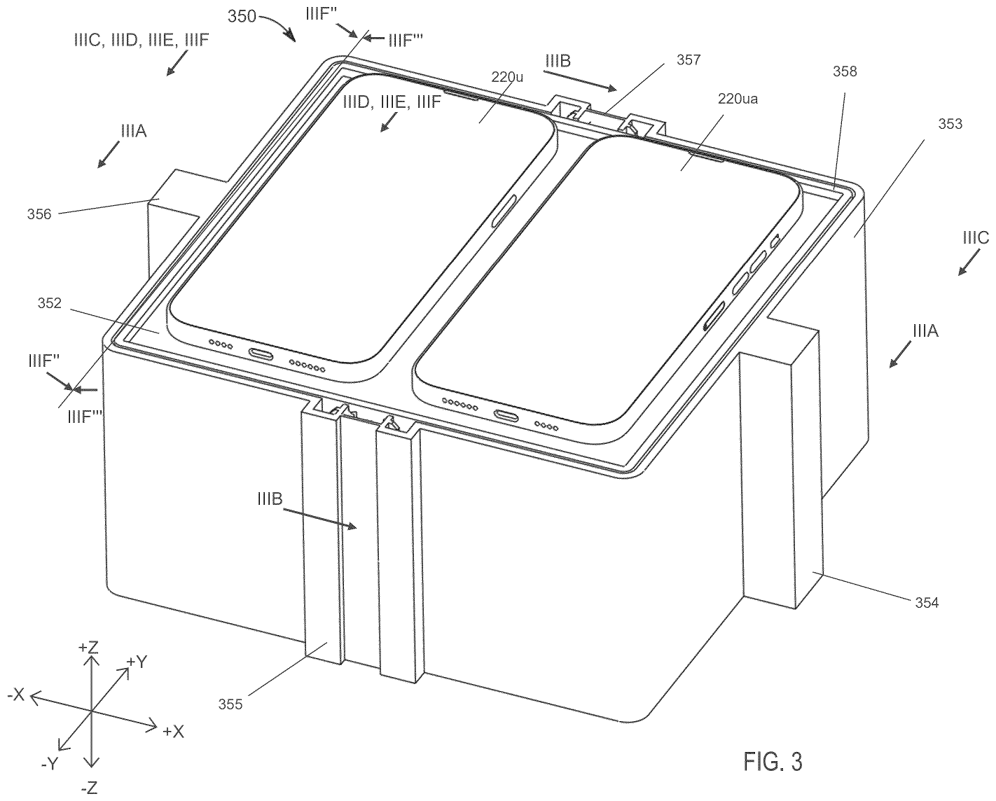

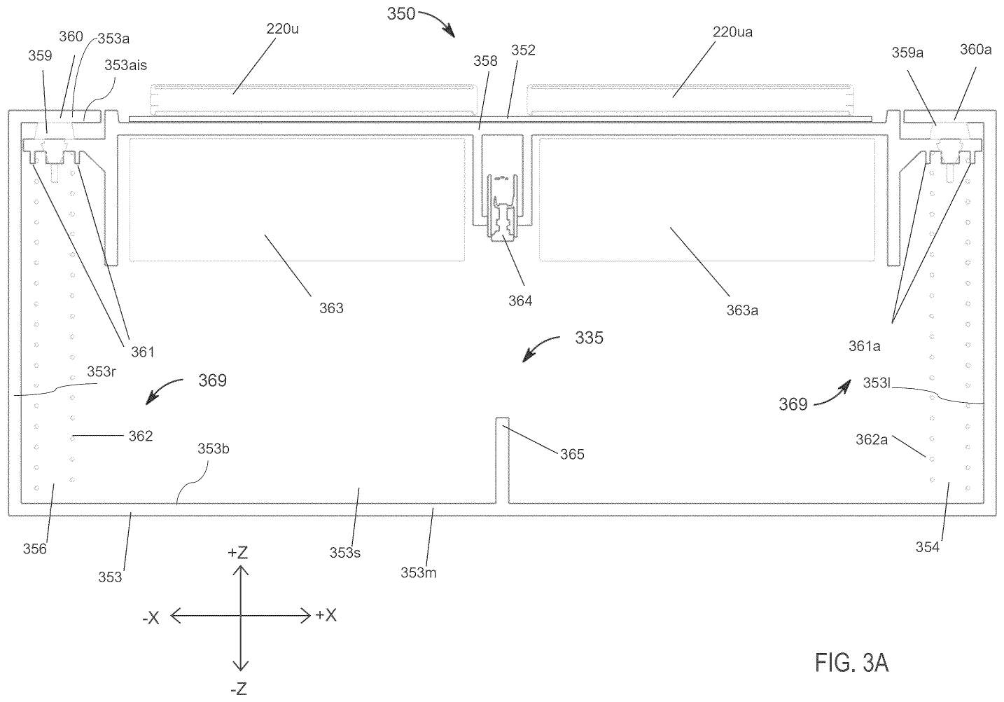

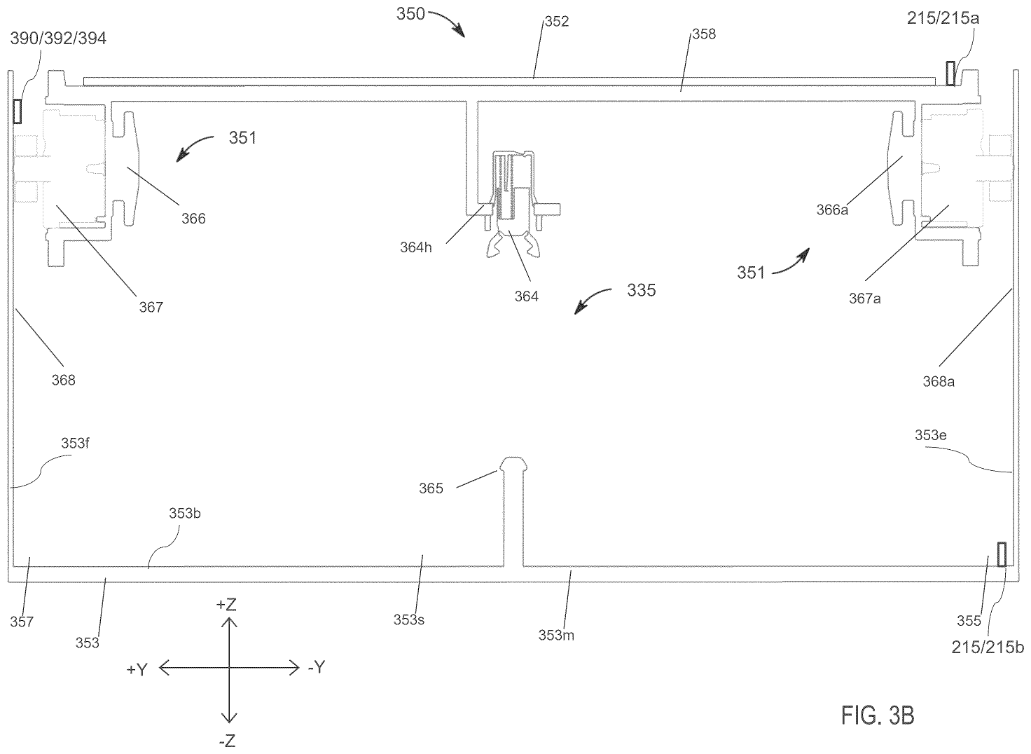

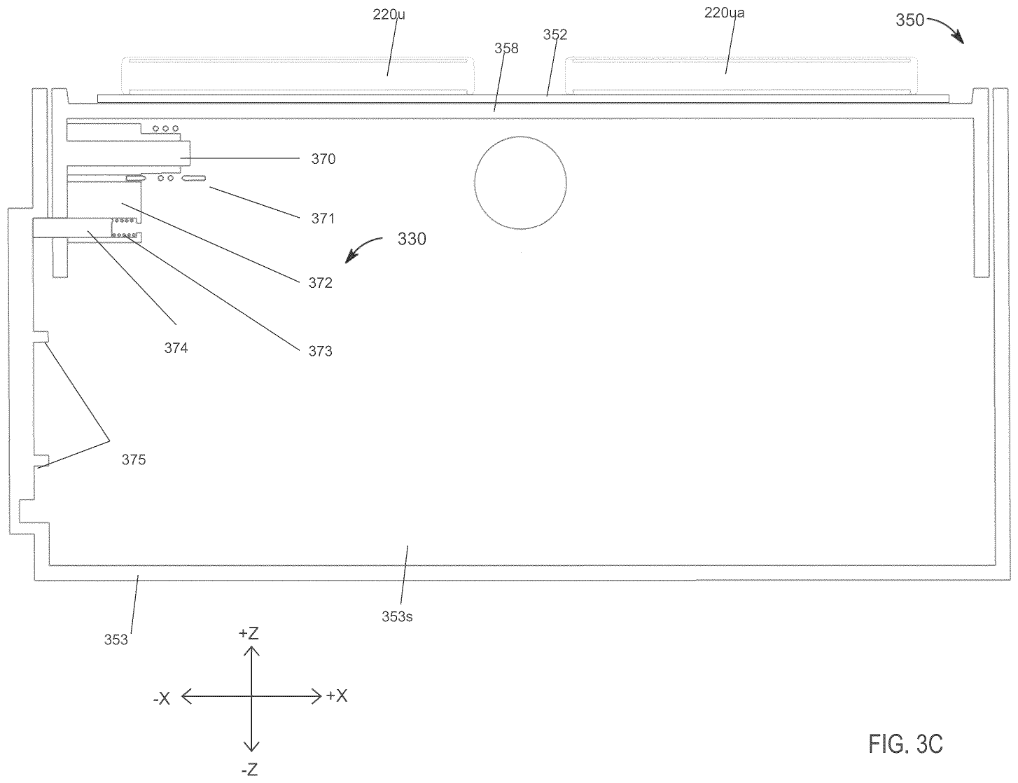

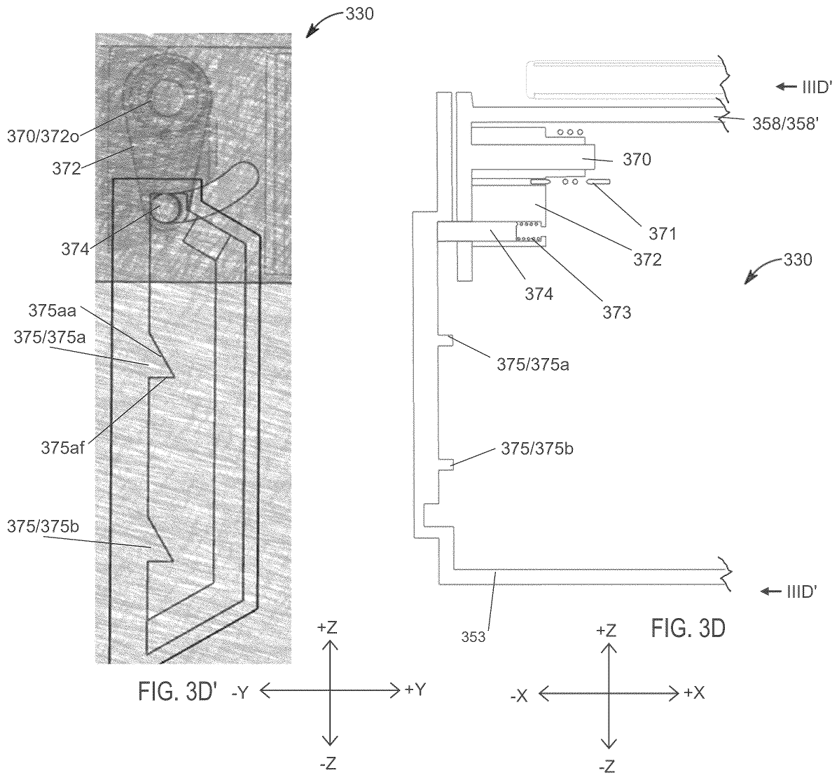

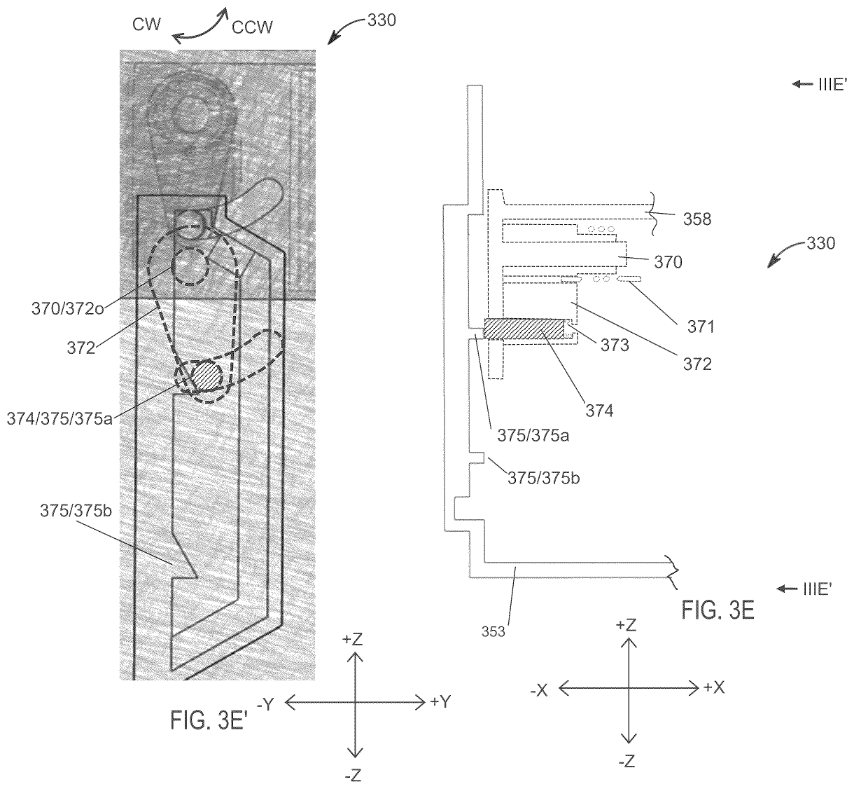

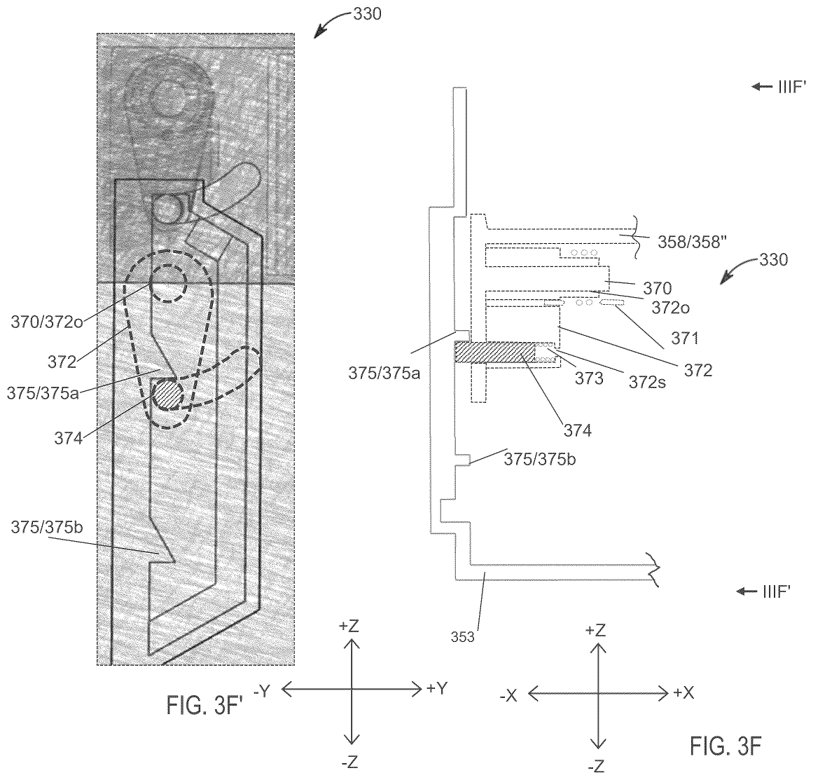

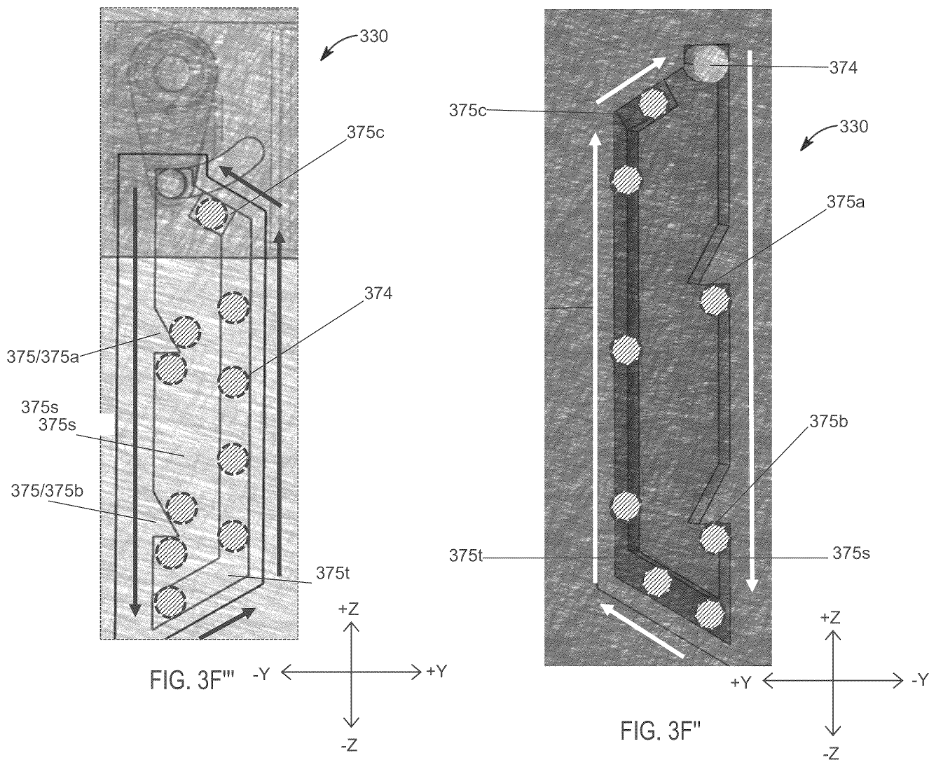

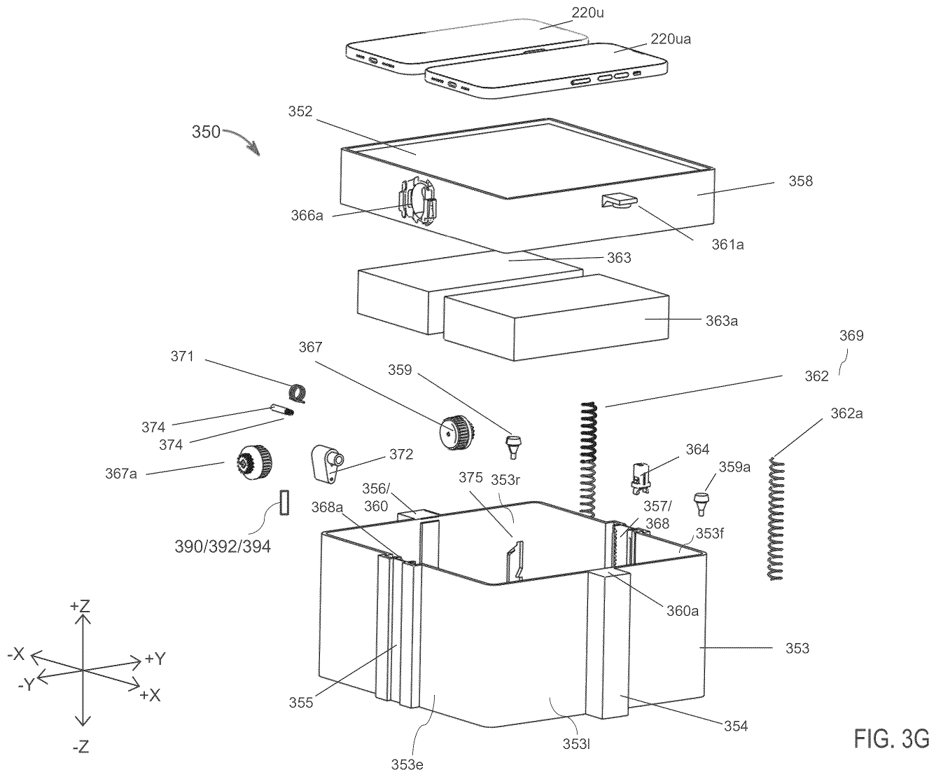

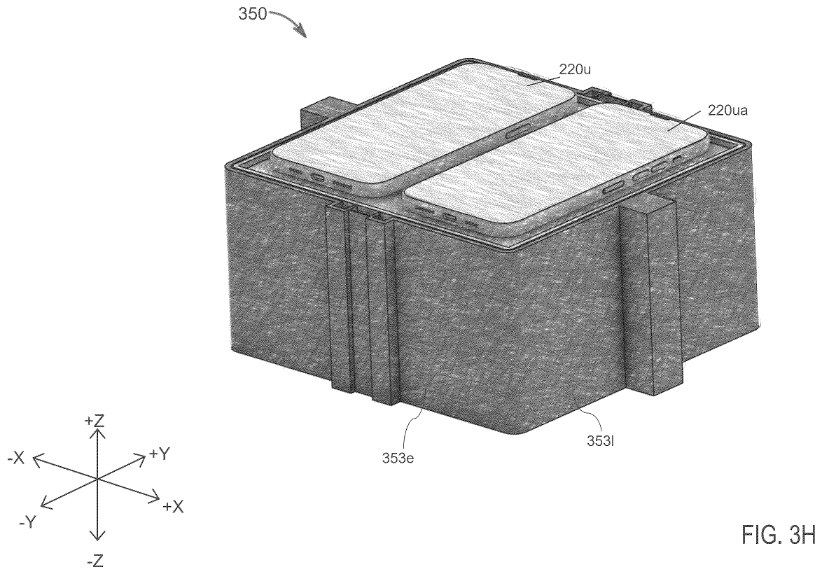

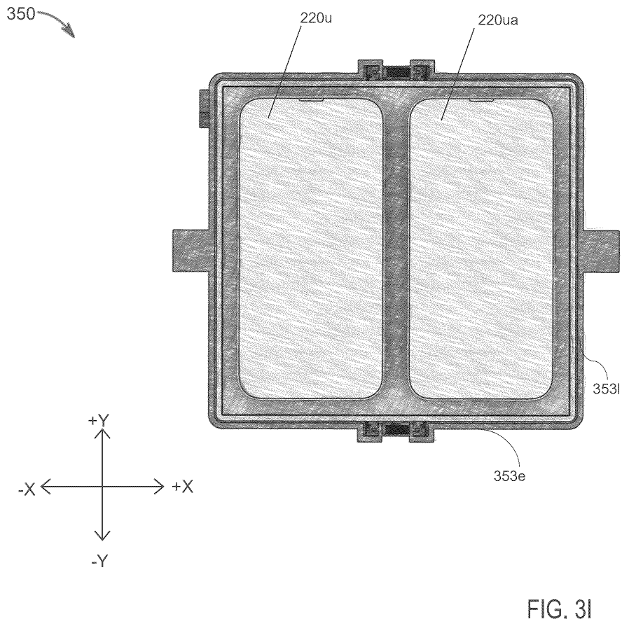

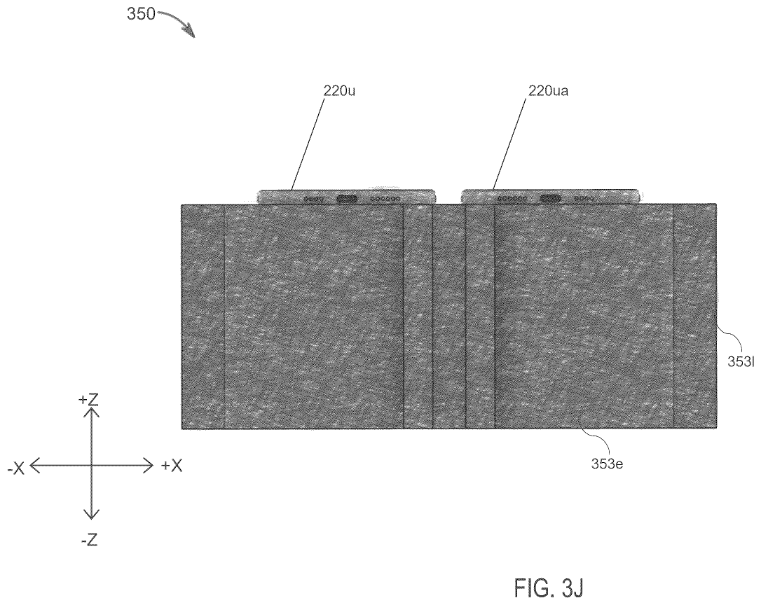

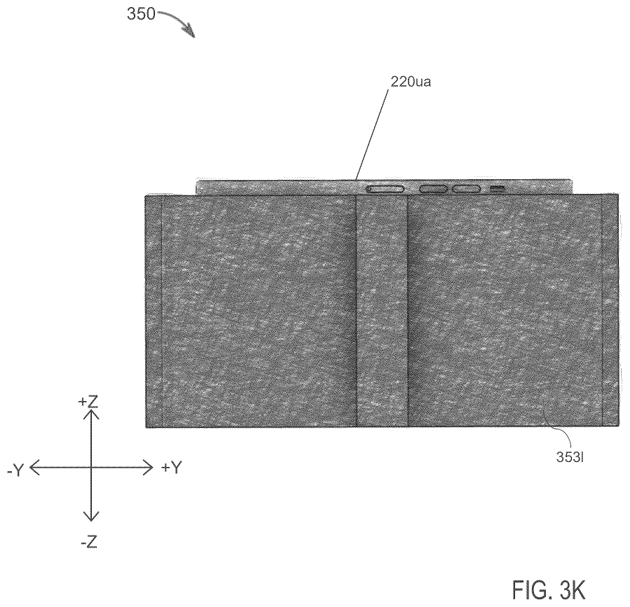

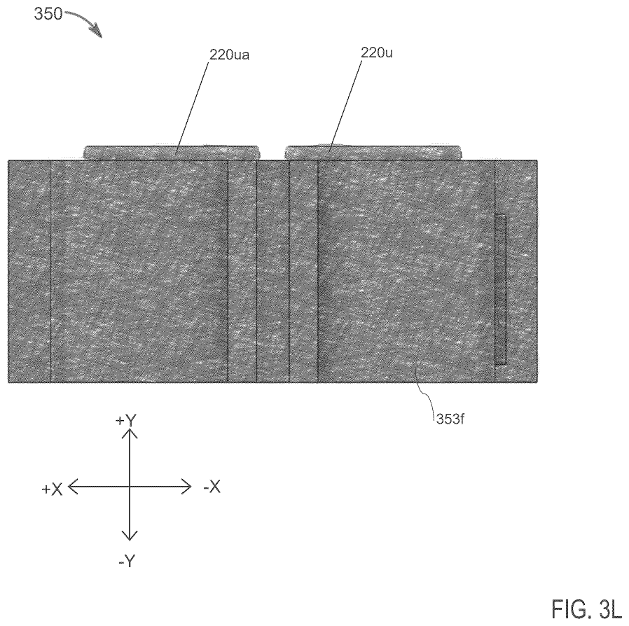

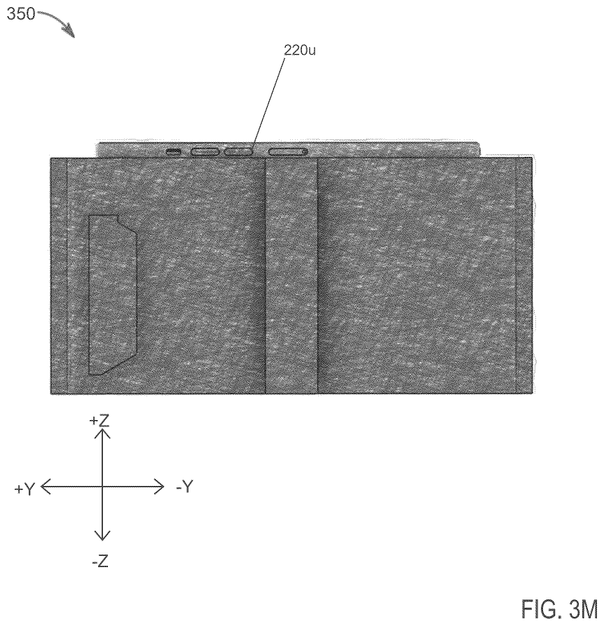

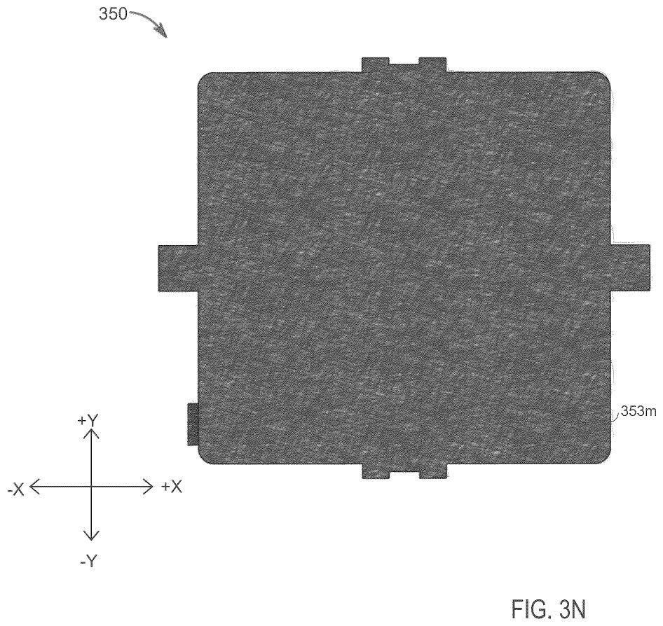

FIGS. 3 and 3A-3N show an illustrative adjustable storage bin system 350 that may be the same as or similar to adjustable storage bin system 250 (e.g., bin 250a or otherwise (e.g., any suitable bin 250b-250m, etc.)). As shown, a carrier traveling assembly or carrier traveling tray or carrier traveling mat 358 (e.g., a thermoplastic and/or metal) of any suitable shape that may be provided to selectively travel with respect to (e.g., relative to) a storage bin carrier 353, such as within a carrier space 353s of carrier 353 (e.g., carrier space 353s may be any suitable three-dimensional shape as may be defined by the interior of any suitable carrier walls (e.g., top wall 353a, bottom wall 353m, left wall 3531, right wall 353r, front wall 353f, and rear wall 353e of carrier 353 (e.g., a thermoplastic and/or metal)) of carrier 353), while adjustable storage bin system 350 may also include, in some embodiments, any suitable top surface component 352 (e.g., a soft top mat tray surface (e.g., textile and/or elastomer)) that may be provided along the top surface of tray or mat 358. For example, mat 358 may be configured to travel (e.g., selectively travel) with respect to (e.g., relative to) storage bin carrier 353 amongst any suitable tray positions, such as a fully up position 358′ of FIG. 2K, a fully down position 358″ of FIG. 2K, an intermediate up position 358″ of FIG. 2K, an intermediate down position 358′ of FIG. 2K, and/or the like, using any suitable tray movement assembly (e.g., locking multi-step assembly 330, push-push latch assembly 335, storage bin motor assembly 390, scissor-type assembly 581, and/or any other suitable tray movement assembly that may be operative to control movement of the tray with respect to the carrier (e.g., to move the tray between and/or hold the tray at different tray positions with respect to the carrier)). Storage bin carrier 353 may be removably or permanently coupled to any suitable portion of any suitable vehicle (e.g., to center console 240c of vehicle 290 (e.g., within any suitable console space 241s (e.g., within bin space portion 241sb of console space 241s) that may be defined at least partially by console 240c and/or any other suitable portion or vehicle bin component of vehicle 290)). In some embodiments, storage bin carrier 353 may be formed as a portion of console 240c (e.g., formed into console 240c when the console is being formed (e.g., storage bin carrier 353 may be formed as a portion of a main carrier or storage bin of console 240c (e.g., by injection molding, gluing, heat stake, etc.))) or may be mounted to console 240c in any suitable way (e.g., bin carrier 353 may be mounted with positive attachments (e.g., fasteners, clips, screws, etc.) to any suitable portion of console 240c (e.g., using any suitable coupling features 251). Spring compartments 354 and 356 may be provided along opposing portions (e.g., sides (e.g., left carrier side wall 3531 and right carrier side wall 353r)) of storage bin carrier 353 (e.g., an open top box-like structure) for housing respective spring components 362 and 362a (e.g., steel), each of which may be held between a bottom interior surface 353b (e.g., of bottom carrier wall 353m) of storage bin carrier 353 and a respective spring guide housing 361 and 361a of a bottom surface of carrier traveling mat 358 for enabling any suitable spring-loaded (e.g., manual push-push type) mechanism for positioning mat 358 at various positions with respect to carrier 353 (e.g., along the Z-axis (e.g., positions (e.g., positions 358′-358″) that may be defined by a push-push-latch 364 that may be configured to engage with a push-push-latch tab 365 (e.g., as may be extending from bottom interior surface 353b of carrier 353) (e.g., an assembly 335 (e.g., push-push latch assembly)) and/or by stopper surface(s) 375 (e.g., as may be tab surface(s) extending out from a side interior surface 353r is of carrier side wall 353r of carrier 353 or notch surfaces extending into a side interior surface of carrier 353) for engaging with a locking pin or lever 374 (e.g., an assembly 330 (e.g., a locking multi-step assembly)))). Additional bumper component(s) 359 and/or 359a (e.g., elastomer) may be positioned between a top surface of mat 358 and a bottom surface stopper 360/360a of carrier 353 as control features for promoting smooth travel of mat 358 with respect to carrier 353. Additionally or alternatively (e.g., instead of a manual mechanism for a user to physically manipulate mat 358 up or down with respect to carrier 353), dampener track rails 355 and 357 may be provided along opposing portions (e.g., sides) of storage bin carrier 353 for interacting with respective carrier traveling mat dampener housing components 366a and 366 of dampeners 367a and 367 (e.g., silicone and/or a hard thermoplastic) that may be provided along opposing external portions (e.g., sides) of mat 358 (e.g., components 366/366a may be supporting or physically coupled to or integrated with mat 358) for enabling any suitable electronically controlled servo/motor 392 and/or motor microcontroller 394 of a storage bin motor assembly 390 of bin system 350 to physically manipulate dampeners 367/367a up or down with respect to rails 355/357 and, thus, to physically manipulate mat 358 up or down with respect to carrier 353. For example, in some embodiments, a force may be applied directly on top mat surface 352 (e.g., a downward force in the direction of −Z (e.g., manually by a user)) to adjust the position (e.g., using latch 364 (e.g., assembly 335) and/or a locking multi-step assembly (e.g., assembly 330)). Additionally or alternatively, the movement of mat 358 with respect to carrier 353 between any suitable positions may be controlled electronically through use of any suitable motor/servo 392 (e.g., in place of or in addition to rails 355/357 and/or dampeners 367a/367), which may be activated or otherwise controlled by a motor microcontroller 394 (e.g., automatically or by user manipulation of any suitable physical switch (e.g., switch 216b) or graphical user interface (e.g., touch screen 216a) of any suitable user interface (e.g., I/O interface 216 of subsystem 220f or otherwise of vehicle 290) that may be positioned anywhere within the vehicle) through any suitable system of the vehicle (e.g., via vehicle subsystem 220f or a mechanical switch located on a door trim or any other suitable user accessible location within the vehicle). If movement of the mat is configured to be movable via electronics (e.g., automatically and/or via user interface (e.g., rather than by a user's physical manipulation of the mat using a manual push-push type mechanism or otherwise), such as via storage bin motor assembly 390), then one or more sensors (e.g., sensors 215a/215b) of an electronic control system (e.g., control system or processor 212 (e.g., of subsystem 220f), which may include any suitable head unit 212a and/or any suitable body control unit 212b) may be positioned in any suitable position(s) with respect to the mat to determine if there are any obstacles blocking safe movement of the mat in one or more directions and utilize any suitable sensor data to automatically prevent certain electronic movement of the mat until the obstacle has been removed (e.g., a sensor 215b may be positioned below mat 358 (e.g., along surface 353b) or otherwise to determine if there are any distinct objects between sensor 215b and mat 358 (e.g., a stored object 5b of FIG. 2K) that may be an obstacle to downward (e.g., −Z) movement of the mat, and/or a sensor 215a may be positioned above mat 358 (e.g., along or adjacent surface 352) or otherwise to determine if there are any distinct objects between sensor 215a and mat 358 (e.g., a stored object 5a of FIG. 2K) that may be an obstacle to upward (e.g., +Z) movement of the mat). Such sensor(s) may be any suitable sensors, including, but not limited to, a weight sensor, a light sensor, a motion sensor, a camera, and/or the like. Therefore, adjustable storage bin system 350 may utilize a manual push-push, spring loaded type mechanism to maintain and push a tray (e.g., mat 358) into position (e.g., with additional bumpers and/or dampeners as control features for travel smooth up and down) or an electronic controlled servo/motor with the addition of guides to adjust the height of the tray with respect to a storage bin carrier 353. Any suitable power source (e.g., a power source 217 of subsystem 220f) may be configured to power control system 212 and/or user interface 216 and/or motor assembly 390 and/or sensors 215a/215b (see, e.g., FIG. 1D).

FIG. 3A shows spring components 362 and 362a, locator spring housings 361 and 361a, softer rubber stopper elements 359 and 359a, and a primary surface (e.g., an interior bottom surface 353a is of top wall 353a that may be opposite interior top surface 353b of bottom wall 353m) of carrier 353 providing or coupled to surface stoppers 360 and 360a. Moreover, any suitable device modules 363 and 363a of system 350 may be illustrated in FIG. 3A and may be used to functionally couple to (e.g., via mat 358 (e.g., via top mat surface 352)) respective portable user electronic devices 220u and 220ua (e.g., to electrically couple thereto (e.g., for charging power component(s) of the device(s) (e.g., using any suitable power supply of the vehicle)) and/or to communicatively couple thereto (e.g., for communicating any suitable data between devices (e.g., for communicatively coupling device 220u and/or device 220ua with any other suitable device(s) (e.g., vehicle subsystem 220f), such as for synchronizing a portable user device with a vehicle infotainment system device))). Module 363 and/or module 363a may be any suitable wireless charging module and/or physical connector and may be coupled (e.g., electrically (e.g., via any bus 18 or otherwise) to any suitable electronic subsystem of vehicle 290 (e.g., subsystem 220f)). When a portable user electronic device (e.g., device 220u and/or device 2220ua (e.g., a smartphone, tablet, etc.)) is positioned on mat 358 of adjustable storage bin system 350, the user device may be electrically coupled to any other suitable subsystem of vehicle 290 (e.g., via module 363 and/or module 363a). For example, one or more suitable data and/or power connectors (e.g., USB-C connector) may be provided by module 363/363a of adjustable storage bin system 350 for interacting with the user device(s). In some embodiments, module 363/363a may be an I/O component 16 of any suitable vehicle subsystem (e.g., vehicle subsystem 220f) that may be any suitable data and/or power connector (e.g., a Universal Serial Bus (“USB”) connector or any other suitable connector type (e.g., male or female)) that may be physically connected or otherwise coupled to a connector (e.g., female or male) of user device 220u when user device 220u is positioned on mat 358 in a mating position with such a connector of adjustable storage bin system 350 and/or an I/O component 16 of any suitable vehicle subsystem (e.g., vehicle subsystem 220f) that may be any suitable data and/or power connector (e.g., a wireless charger (e.g., an inductive charging pad or the like)) that may be functionally coupled to user device 220u when user device 220u is positioned on mat 358 of adjustable storage bin system 350. Any suitable bus(es) 18 may communicatively/functionally couple device modules 363 and 363a to any suitable other components of any suitable vehicle subsystem (e.g., processor 12, communications component 14, and/or power supply 17 of vehicle subsystem 220f). Therefore, when positioned on mat 358 of adjustable storage bin system 350, not only may user device 220u be supported (e.g., physically) by adjustable storage bin system 350, but device 220u may also be coupled (e.g., electrically, communicatively, power chargingly, or otherwise functionally) to any vehicle subsystem(s) via any suitable I/O component(s) within or adjacent storage bin system 350 for any suitable purpose(s) (e.g., charging of device 220u and/or synchronization (e.g., media synchronization) of user device 220u with any vehicle subsystem (e.g., synchronization of a screen of vehicle subsystem 220f with a screen of user device 220u or otherwise)). In some embodiments, once a user device 220u is functionally positioned on mat 358 (e.g., once device 220u begins charging with module 363 and is communicatively coupled to (e.g., synchronized with) a vehicle subsystem (e.g., subsystem 220f, such that the device may be functionally used via subsystem 220f (e.g., such that a user interface of user device 220u may be transferred to a user interface of vehicle subsystem 220f such that any suitable data and/or functionality of user device 220u may be utilized by vehicle subsystem 220f and/or such that any suitable power and/or data of vehicle subsystem 220f may be transferred to user device 220u))) or otherwise detected to be properly positioned on mat 358 for any suitable amount of time (e.g., using any suitable sensor(s) of module(s) 363/363a and/or the like (e.g., sensor(s) 215a/215b)), the system may be configured to automatically lower mat 358 down into the carrier to initiate any suitable deep storage mode (e.g., the system may automatically detect the functional positioning of a phone on the mat and then automatically lower the mat so that the phone is moved out of view of the user and more carrier storage space is made available above the mat).

FIG. 3B shows dampener track rails 355 and 357, respective contact surfaces identified as track rail guides 368 and 368a, and bin carrier traveling mat dampener housings 366 and 366a that may be used to secure respective dampeners 367 and 367a, which may travel through dampener track rails 355 and 357, respectively. Additionally, a push-push-latch holder 364h with push push-latch 364 may be provided at a bottom surface of mat 358 while push-push-latch-tab 365 may be provided at an interior bottom surface 353b of carrier 353 or otherwise to provide a push-push latch assembly 335 that may be configured to secure mat 358 with respect to carrier 353 in a bottom position. Push push-latch 364 may be configured to hold mat 358 in a particular position with respect to carrier 353 (e.g., any suitable position(s), such as fully down position 358″ of FIG. 2K (e.g., a fully down storage position), intermediate up position 358″ of FIG. 2K, intermediate down position 358″ of FIG. 2K, and/or the like) while engaging push-push-latch-tab 365, then it may be pushed again (e.g., by a user via mat 358 (e.g., in the −Z direction)) passed the fully down position 358″ to a bottom release position such that tab 365 may release (e.g., disengage) latch 364 whereby mat 358 may be released back up (e.g., in the +Z direction) to fully up position 358′.

FIGS. 3C-3F′″ show a front edge of adjustable storage bin device 350, revealing a locking multi-step assembly 330 of device 350 that may be configured to enable mat 358 to stop at different levels or positions (e.g., fully up position 358′ of FIG. 2K, intermediate up position 358″ of FIG. 2K, intermediate down position 358′″ of FIG. 2K, and/or the like) before engaging push-push latch assembly 335 (e.g., before engaging together push-push-latch 364 and tab 365) for holding mat 358 at a fully down position (e.g., for holding mat 358 at fully down position 358″ of FIG. 2K (e.g., a fully down storage position)). A pivot axis in mat 358 (e.g., a carrier traveling lever axis feature 370 of mat 358) may be rotatably holding a lever guide 372 (e.g., a thermoplastic and/or metal) and a spring loaded component 371 (e.g., a spring (e.g., steel) that may bias guide 372 for a particular rotation about axis feature 370 of mat 358 (e.g., when feature 370 may extend through a guide opening 3720 in guide 372)), whereby guide 372 may rotate about feature 370 (e.g., about an X-axis), while a lever spring 373 may be positioned within a slot 372s in guide 372 to bias a lever 374 at least partially in slot 372s (e.g., outward (e.g., in −X direction)) to secure a position of mat 358 with respect to one of potentially multiple different stopper surface(s) 375 (e.g., steel). As shown in a progression of assembly 330 of device 350 from a configuration of FIGS. 3D and 3D′ (e.g., fully up position 358′) to a next configuration of FIGS. 3E and 3E′ to a next configuration of FIGS. 3F and 3F′ (e.g., intermediate up position 358″) as mat 358 is moved downward (e.g., in the −Z direction) with respect to carrier 353, guide 372 may rotate (e.g., as a cam) about feature 370 of mat 358 in a first direction (e.g., direction CCW) (e.g., against a bias of component 371) when lever 374 may interact with an angled surface 375aa of a stopper 375 as mat 358 is moved downward with respect to carrier 353 and stopper 375 (e.g., against a bias of spring component(s) 362/362a), and then guide 372 may rotate back in a second direction (e.g., direction CW) opposite the first direction (e.g., using a bias of component 371) when lever 374 has moved down beyond stopper 375, such that a bottom (e.g., flat) surface 375af of stopper 375 may interact with lever 374 to hold mat 358 in a position with respect to stopper 375, even when a downward force on mat 358 may be terminated while lever 374 is biased towards and against side interior surface 353r is under stopper 375 (e.g., by spring 373 and spring component(s) 362/362a). However, when lever 374 is pulled away from side interior surface 353r is and from under stopper 375 (e.g., in a +X direction further into slot 372s (e.g., using any suitable user controlled mechanism)), lever 374 may disengage with stopper 375 and mat 358 may be able to move upward (e.g., in the +Z direction (e.g., due to bias of spring component(s) 362/362a)) without interference from stopper 375. Alternatively, as shown in FIGS. 3F″ and 3F″, system 350 may be configured such that lever 374 may be pushed further into side interior surface 353r is (e.g., in a −X direction (e.g., using the bias of spring 373)) when mat 358 is pushed further downward (e.g., in the −Z direction opposite the bias of spring component(s) 362/362a (e.g., by a user's manual downward pressure)) beyond the bottom surface of the lowest stopper (e.g., lower stopper 375b), whereby lever 374 may be aligned with and be pushed into a deep return track 375t that may be formed into side interior surface 353r is in the −X direction beyond the depth of a stopper track 375s in side interior surface 353r is adjacent stoppers 375 (e.g., when mat 358 is pushed further downward (e.g., in the −Z direction opposite the bias of spring component(s) 362/362a) beyond the bottom surface of the lowest stopper (e.g., lower stopper 375b), the free end of lever 374 may transition from abutting stopper track 375s of side interior surface 353r is in the −X direction to abutting the deeper return track 375t of side interior surface 353r is in the −X direction). Then, once a downward pressure on mat 358 is released (e.g., by a user), the upward bias of spring component(s) 362/362a may push mat 358 upwards (e.g., in the +Z direction) whereby lever 374 may travel upwards along return track 375t rather than along stopper track 375s, such that lever 374 may not be stopped by stopper(s) 375. A connector track 375c in side interior surface 353r is may enable lever 374 to transition from the depth of the top of track 375t to the depth of the top of track 375s for returning mat 358 to its top position 358′. There may be any suitable number of different stoppers 375 (e.g., spaced apart along the Z-axis) for defining different positions of mat 358 with respect to carrier 353 (e.g., an intermediate up position 358″ (e.g., with an upper stopper 375a), an intermediate down position 358″ (e.g., with a lower stopper 375b), and/or the like). Dampener housing components 366a and 366 of dampeners 367a and 367 may be configured as dampeners to control speed of a system for moving mat 358 with respect to carrier 353 (e.g., along the Z-axis) and/or to control tracking (e.g., a gear may be provided to run on a silicon component to ensure the mat moves up and down rather than side to side, where a tactile softness may be enabled). In some embodiments, a dampener may be substituted by a powered motor in an electric assembly, which may not need assembly 330 and/or assembly 335. In some embodiments, both an electrical movement assembly (e.g., assembly 390) and a mechanical movement assembly (e.g., assembly 330, 335, etc.) may be provided in system 350 and either may be selectively used by a user at any given time.

While mechanical locking multi-step assembly 330 may only be shown along one side of carrier 353 (e.g., stopper(s) 375 along the −X side wall 353r), it is to be understood that another mechanical locking multi-step assembly may additionally or alternatively be provided on the opposite side (e.g., along the +X side wall 3531) and/or any additional area(s) (e.g., Y-side wall(s), corner(s), center, etc.) to provide a differently positioned and/or more robust solution. While spring compartments 354 and 356 and respective springs 362a and 362 of a spring assembly 369 may only be shown along opposing portions (e.g., sides) of carrier 353 (e.g., opposing sides along the X-axis (e.g., side walls 3531 and 353r of carrier 353)) for providing Z-axis spring bias to mat 358 with respect to carrier 353, it is to be understood that such spring(s) may be provided in any additional or alternative locations with respect to carrier 353, such as opposing sides along the Y-axis, in each of the four corners, in the center (e.g., about latch 364 and tab 365), and/or the like. While latch 364 and tab 365 may only be shown extending along the Z-axis within the center of carrier 353 for providing latch assembly 335, it is to be understood that such latch assembly components may be provided in any additional or alternative locations with respect to carrier 353, such as along one side of the carrier, in a corner of the carrier, or two or more such latch assemblies may be provided for working in tandem to provide a more robust solution (e.g., in two opposite corners or along two opposing walls, etc.). While dampener housing components 366a/366 of dampeners 367a/367 working with rails 355/357 and guides 368a/368 may only be shown along opposing portions (e.g., sides) of carrier 353 (e.g., opposing sides along the Y-axis (e.g., side walls 353e and 353f of carrier 353)), it is to be understood that such dampener housing component(s), dampener(s), track(s), and rail(s) of a dampener assembly 351 may be provided in any additional or alternative locations with respect to carrier 353, such as opposing sides along the X-axis, on each of the four sides, in the four corners, and/or the like.

In some embodiments, by positioning mechanical locking multi-step assembly 330, springs of spring assembly 369, dampener guides/rails of dampener assembly 351, and/or latch assembly 335 in or near corners and/or in a center of carrier 353, rather than along a middle portion or otherwise of one or more sides 3531, 353r, 353f, and 353e of carrier 353, one or more side storage bin openings may be more easily provided through one or some or each of sides 3531, 353r, 353f, and 353e of carrier 353 for enabling the passage of any suitable objects (e.g., user device 220u, an object 5a, an object 5b, etc.) therethrough. In other embodiments, a side storage bin opening may be provided through a carrier side wall along which dampener guides/rails of a dampener assembly may also be provided and/or a side storage bin opening may be provided through a carrier side wall along which stopper surfaces of a locking multi-step assembly may also be provided.

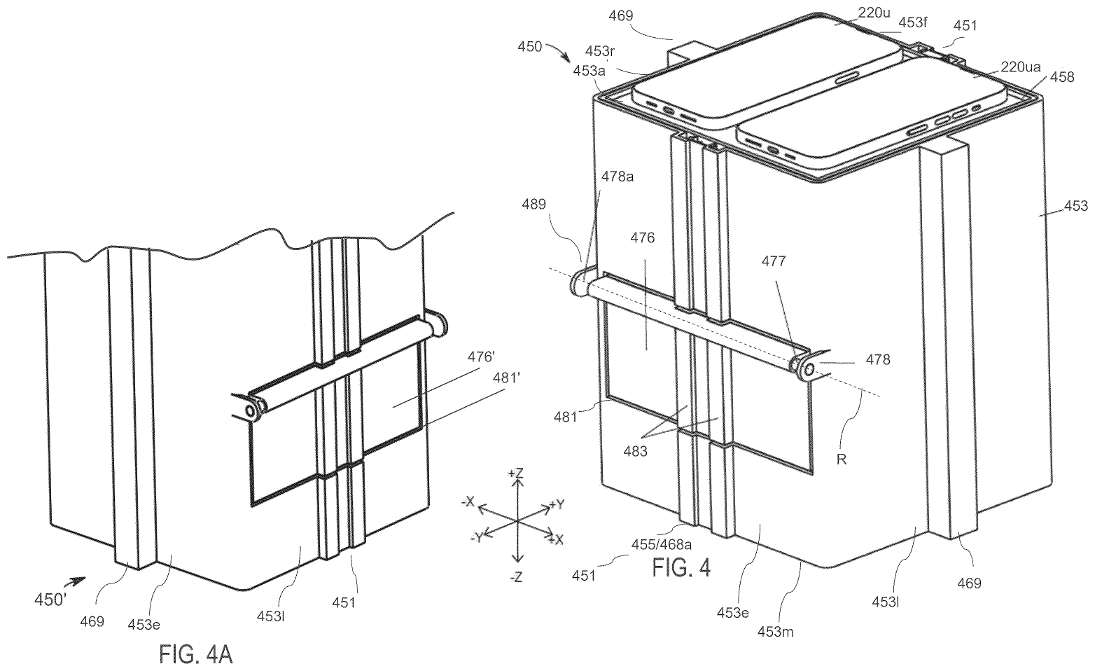

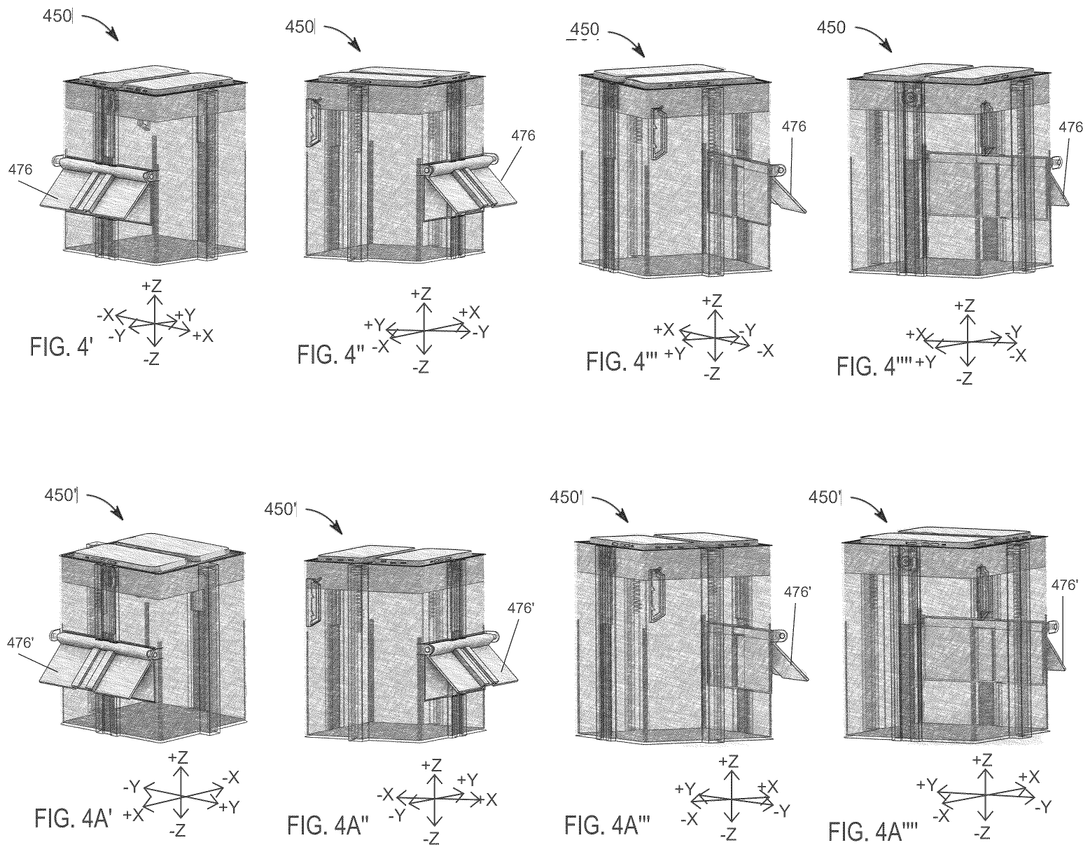

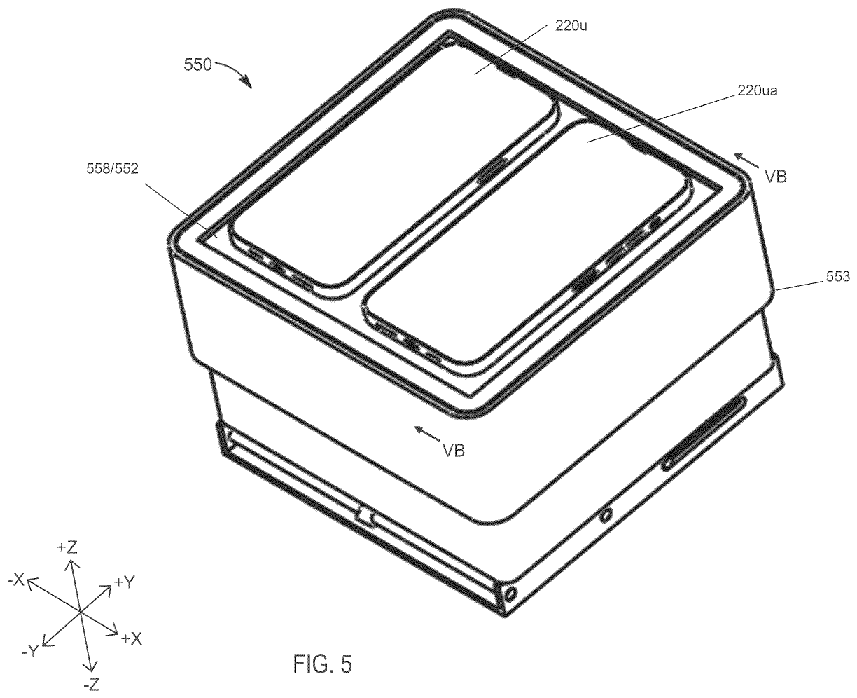

FIGS. 4 and 4′-4″ show another illustrative adjustable storage bin system 450 that may be the same as or similar to adjustable storage bin system 250 (e.g., bin 250a or otherwise (e.g., any suitable bin 250b-250m, etc.)) and/or storage bin system 350. As shown, adjustable storage bin system 450 may include a carrier traveling mat 458 that may be provided to selectively travel with respect to a storage bin carrier 453, which may be removably or permanently coupled to any suitable portion of any suitable vehicle (e.g., center console 240c of vehicle 290). Bin system 450 may include dampener guides/rails of a dampener assembly 451 on opposing sides 453e and 453f of carrier 453, spring compartments and respective springs of a spring assembly 469 on opposing sides 4531 and 453r of carrier 453. However, unlike bin system 350, bin system 450 may be shown to include at least one side storage bin opening provided through a side wall of carrier 453. For example, as shown in FIGS. 4 and 4″, a side storage bin opening 481 may be provided through (e.g., extends through a portion of) side wall 453e of carrier 453, which may include any suitable dampener guides/rails 455/468a of dampener assembly 451, while a side storage bin door 476 (e.g., a thermoplastic and/or metal) may be provided to selectively reside within opening 481 for defining any suitable functional features 483 (e.g., a thermoplastic and/or metal) that may functionally replace any suitable portions of dampener guides/rails of dampener assembly 451 that might otherwise be defined by the portion of side wall 453e taken up by opening 481, whereby features 483 of door 476 and guides/rails 455/468a of wall 453e may together seamlessly provide the functionality for dampener assembly 451 when door 476 is in its closed configuration within opening 481 (alternatively, in some embodiments, features (e.g., features 483) of a door and spring compartment(s) or otherwise of any suitable spring assembly of any suitable wall (e.g., spring assembly 469 of wall 4531) and/or stopper surface(s) (e.g., surface(s) 375) of any suitable wall may together seamlessly provide the functionality for a push-push latch and/or locking multi-step assembly when the door is in its closed configuration within a door opening). Although opening 481 may be shown to span a majority of the X-axis width of wall 453e (e.g., intersecting dampener assembly 451), opening 481 may alternatively span a portion of the X-axis width of wall 453e that does not intersect dampener assembly 451 (e.g., a width portion between assembly 451 and a Z-axis edge of wall 453e), such that door 476 may not include any functional features 483 as it may not intersect or interfere with assembly 451 of bin system 450. While side storage bin opening 481 may only be shown to be provided through side wall 453e of carrier 453 of bin system 450 (e.g., a side wall in a X-Z plane), it is to be understood that a side storage bin opening may be additionally or alternatively provided through any other suitable portion of a carrier of a bin system, such as through a perpendicular side wall (e.g., a side wall in a Y-Z plane, as may be shown by opening 481′ through wall 4531 of bin system 450′ of FIGS. 4A and 4A′-4A″) and/or through two or more side walls of the same bin (e.g., a first opening 481 through side wall 453e and a second opening through side wall 4531 of the same bin).

Door 476 may be selectively opened or closed with respect to opening 481 for enabling any suitable objects to be passed through opening 481 between a carrier space (e.g., as may be defined by the interior surfaces of carrier walls 453a, 453m, 453r, 4531, 453f, 45e, and/or the like) and an environment external to carrier 453 when door 476 is in an open position. Any suitable door movement assembly 489 may be provided for enabling door 476 to move between its open and closed positions with respect to opening 481. For example, carrier 453 may include door axis tabs 478 and 478a (e.g., a thermoplastic and/or metal) of an assembly 489 that may be positioned on any two opposing sides of opening 481 (e.g., extending outwardly from carrier 453 about opposing upper external sides of opening 481) and that may support a door axis feature 477 (e.g., steel) of assembly 489 extending along a rotation axis R between tabs 478 and 478a, whereby feature 477 may be supported by yet free to rotate (e.g., about an X-axis) with respect to tabs 478 and 478a, and feature 477 may be integrated into or coupled to door 476 such that door 476 may rotate with feature 477 about rotation axis R for opening or closing door 476 with respect to opening 481. Feature 477 may be spring biased to rotate for opening door 476 outwardly away from carrier 453 but may be held closed by any suitable push-push latch/tab or otherwise. Any other suitable type(s) of door movement assembly may be utilized for selectively opening and/or closing door 476 with respect to opening 481 (e.g., mechanical and/or electrical mechanism(s) (e.g., servo/motor) that may allow a user to selectively open or close the door via physical force or user interface engagement and/or that may allow the door to be manipulated automatically (e.g., in response to certain events (e.g., when mat 458 lowered to a position aligning with opening 481, a cam may be configured to release a spring that may push open door 476))). As another example, assembly 489 may be configured to provide a counter force to bias door 476 in a closed position with respect to opening 481 (e.g., with a spring), such that functional features 483 may be used by dampener assembly 451 when mat 458 may be traveling up and down within carrier 453 (e.g., along the Z-axis) and/or such that a user's fingers may not be dangerously passed through opening 481 when the mat is being moved, whereby the mat may travel up and down with dampened velocity, and such that door 476 may be opened (e.g., rotated about axis R) to allow objects to pass through opening 481 from mat 458 or otherwise within the carrier space to an environment external to the carrier (e.g., to an alternative storage zone (e.g., remaining portion 241sr of console space 241s) and/or to a space external from the console (e.g., to remove the object from the vehicle altogether) when the mat is not moving).

As shown in FIG. 2K, bin system 450 may be used to position mat 458 (e.g., up or down along mat movement axis MMA (e.g., along a Z-axis)) to a position aligned with opening 481 (e.g., to position 358′″) such that the mat and/or any device(s) thereon may then be moved out from carrier space 353s into remaining portion 241sr of console space 241s via opening 481 (e.g., sideways along mat movement axis MSA (e.g., along a Y-axis)), and then the object may be removed from portion 241sr of console space (e.g., into ambient space 298as external from console space 241s (e.g., a portion of space 290us)) via console opening 240coa (e.g., along an X-axis). Console opening 240coa may be protected by its own door 240coad that may be hidden or lockable to further hide or protect portion 241sr of console space 241s until it is to be accessed via opening 240coa by a user (e.g., door 240coad may be controlled by mechanically and/or electronically by a user and/or automatically due to any suitable events). The mat or any other objects (e.g., device 220ua on the mat or an object 5b below the mat) may be removed from the carrier into space 241sr (e.g., onto support surface 241srl) manually by a user via opening 481 and either opening 240coa or opening 240com or automatically via opening 481 by any suitable mat/object ejection assembly 299 (e.g., an assembly (e.g., electromechanical mechanism) configured to eject the mat outwardly along axis MSA automatically or in response to some user interface event). For example, a user could extend their arm down through opening 240com and slide device 220ua off of the mat in position 358′″ in a-Y direction along axis MSA through opening 481 and onto support surface 241srl, then the mat could be raised to position 358′ such that the device may only be accessible on support surface 241srl via opening 240coa or only after the mat was lowered back to position 358′ or lower. This may provide some additional security for the device. In such embodiments, that bin opening may not be selectively closed by a door, but instead the bin opening may remain open and console opening 240coa may be provided with a door that may securely lock or otherwise hide the bin opening and support surface 241srl when not being accessed by the user. Additionally or alternatively, as shown in FIGS. 2K and 4A-4A″, an opening 481′ may be provided via wall 4531 of bin 450′, such that an object may be removed from the mat at position 358″ via that bin opening (e.g., along the X-axis) and then via console opening 240cob (e.g., also along the X-axis). In such embodiments, that bin opening may not be selectively closed by a bin door, but instead the bin opening may remain open and console opening 240cob may be provided with a door 240cobd that may securely lock or otherwise close to hide the bin opening when not being accessed by the user via opening 240cob (e.g., door 240cobd may be controlled by mechanically and/or electronically by a user and/or automatically due to any suitable events).

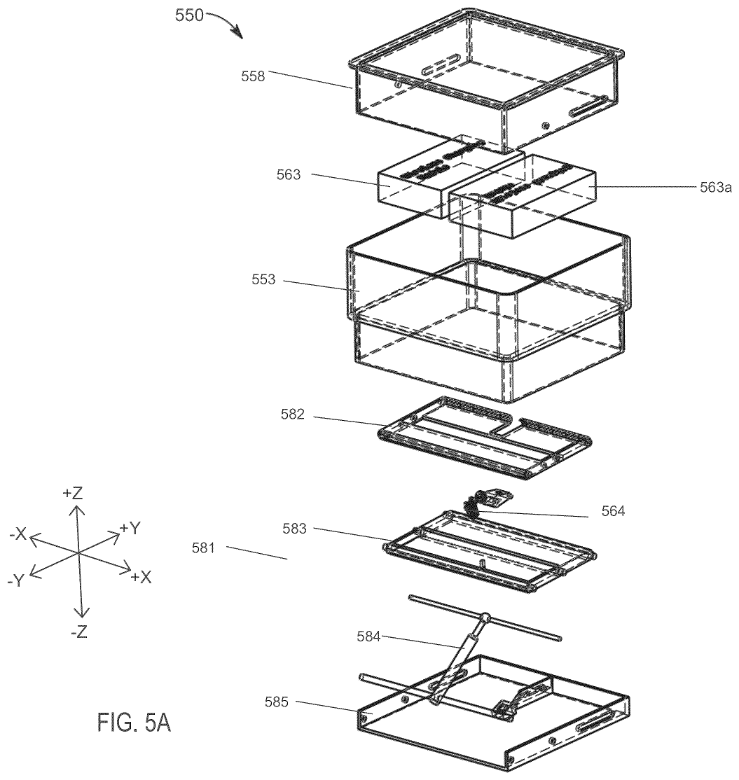

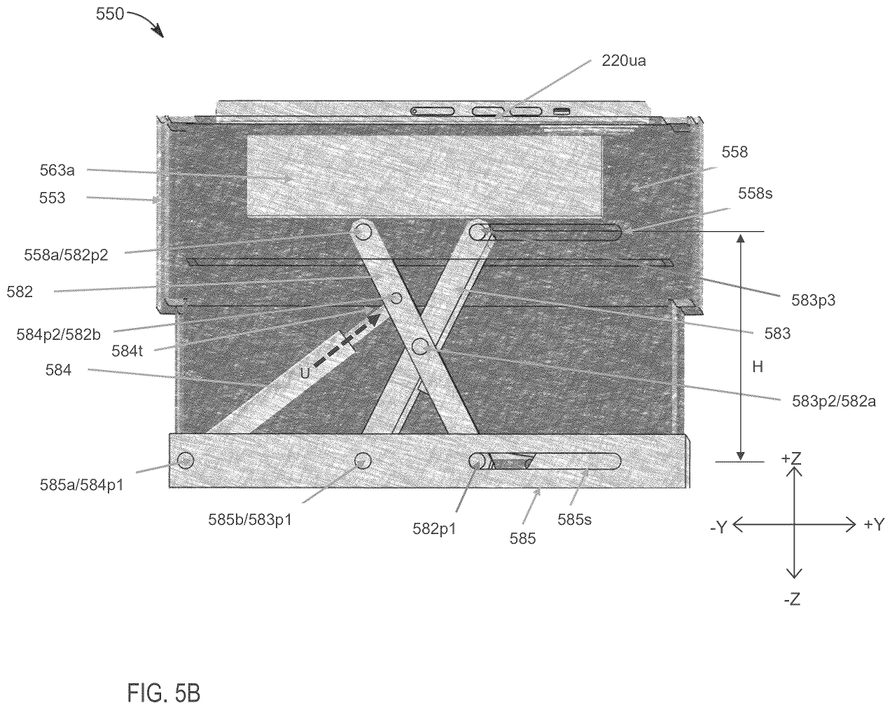

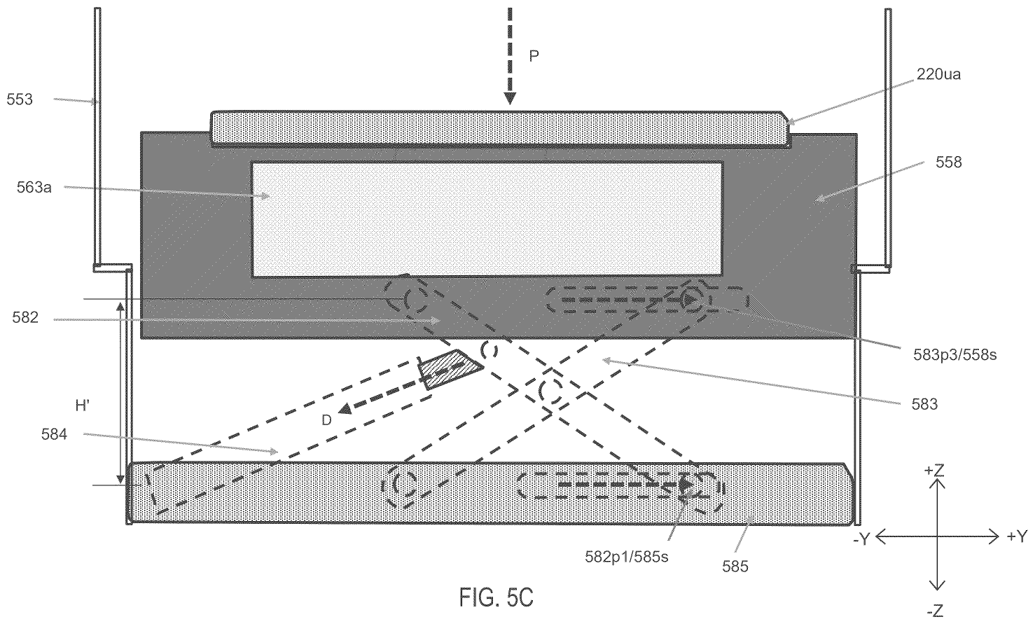

FIGS. 5 and 5A-5C show another illustrative adjustable storage bin system 550 that may be the same as or similar to adjustable storage bin system 250 (e.g., bin 250a or otherwise (e.g., any suitable bin 250b-250m, etc.)) and/or storage bin system 350 and/or storage bin 450 and/or storage bin 450′. Adjustable storage bin system 550 may include a scissor-type assembly 581 to achieve adjustability of a mat 558 (e.g., with or without module(s) 563/563a) with respect to a carrier 553 (e.g., up and down along the Z-axis). Scissor-type assembly 581 may include a scissor slide plate upper component 582 (e.g., a thermoplastic and/or metal), a scissor slide plate lower component 583 (e.g., a thermoplastic and/or metal), a strut component 584 (e.g., a gas loaded (e.g., gas pressurized) or fluid loaded strut (e.g., metal) component), a scissor sliding plate 585, and a push-push latch 564. A pin 584p1 at a first end of strut 584 may be rotatably positioned within a slot 585a of scissor sliding plate 585 (e.g., rotatable about an X-axis), a pin 584p2 at a second end of strut 584 (e.g., at a free end of a piston 584t of strut 584) may be rotatably positioned within a slot 582b positioned along a length of scissor slide plate upper component 582 (e.g., rotatable about an X-axis), a pin 582p2 at a first end of scissor slide plate upper component 582 may be rotatably positioned within a slot 558a of mat 558 (e.g., rotatable about an X-axis), a pin 582p1 at a second end of scissor slide plate upper component 582 may be slidably positioned within a slide slot 585s of scissor sliding plate 585 (e.g., slidable along a Y-axis), a pin 583p1 at a first end of scissor slide plate lower component 583 may be rotatably positioned within a slot 585b of scissor sliding plate 585 (e.g., rotatable about an X-axis), a pin 583p2 positioned along a length of scissor slide plate lower component 583 may be rotatably positioned within a slot 582a positioned along a length of scissor slide plate upper component 582 (e.g., rotatable about an X-axis), and a pin 583p3 at a second end of scissor slide plate lower component 583 may be slidably positioned within a slide slot 558s of mat 558 (e.g., slidable along a Y-axis). Assembly 581 may be configured to adjust its height, such as from height H of FIG. 5B to height H′ of FIG. 5C (e.g., for lowering the position of mat 558 in the −Z direction within carrier 553). When no load is applied on mat 558 (e.g., when no load P is applied downwardly on a top surface component 552 of mat 558 in the −Z direction), strut 584 may be configured to extend a piston 584t (e.g., in a direction U) to achieve a fully up position of assembly 581 (e.g., “full up”). When a load P is applied downwardly on mat 558 (e.g., on top surface component 552 of mat 558 in the −Z direction (e.g., by a user)), the force may be transmitted through mat 558 and assembly 581, whereby pin 583p3 of scissor slide plate lower component 583 may slide in the +Y direction along slot 558s of mat 558 and whereby pin 582p1 of scissor slide plate upper component 582 may slide in the +Y direction along slot 585s of scissor sliding plate 585, which may compress piston 584t (e.g., in a direction D) into strut 584 and reduce the height of the assembly (e.g., from height H of FIG. 5B to reduced height H′ of FIG. 5C to achieve a down position of assembly 581. Push-push latch 564 may engage with a push-push tab to hold assembly 581 in the down position until later disengagement and removal of any load P, such that piston 584t may extend (e.g., in direction U) to move assembly 581 back to its full up position. A benefit of assembly 581 may be that it relies on geometry of axes, no dampeners, less springs, and/or less complexity than other mat moving assemblies. Carrier 553 may be provided with openings through side walls without impacting the functionality of assembly 581.

Any suitable types of objects (e.g., purses, glasses, food, etc.) may be stored in various locations with respect to an adjustable storage bin system. As shown in FIG. 2K, any suitable object 5c may be stored within console space 241s in a position below or otherwise outside of the bin carrier (e.g., in space 241sr (e.g., on or below surface 241srl)) as may be accessible by a user via console opening 240coc or console opening 240coa (e.g., console opening 240coc may be provided with a door 240cocd that may securely lock or otherwise close to hide the opening when not being accessed by the user (e.g., door 240cocd may be controlled by mechanically and/or electronically by a user and/or automatically due to any suitable events)), any suitable object 5b may be stored within the carrier space of the bin (e.g., within space 241s) below the mat as may be accessible by a user via console opening 240cob or via console opening 240coa and a bin opening (e.g., opening 481), any suitable object 220ua or otherwise may be stored on a top surface of a mat (e.g., on surface 352) as may be accessible by a user via console opening 240com regardless of the mat's position within the carrier space and/or via console opening 240cob and a bin opening (e.g., opening 481′) when the mat is positioned below or at that bin opening and/or via console opening 240coa and a bin opening (e.g., opening 481) when the mat is positioned below or at that bin opening, and/or any suitable object 5a may be stored above the mat when the mat is lowered at least a certain amount below its fully up position (e.g., within a portion of the carrier space above the mat using any suitable holding apparatus 352′ (e.g., a cargo net or retractable sliding support surface) that may be suspended (e.g., automatically or by the user) above the mat (e.g., using hooks along interior side walls of the carrier) when the mat is positioned below the suspension points 352s′ for the holding apparatus and that may be retracted or removed (e.g., automatically or by the user) when the mat is to be accessed or moved upwards)) as may be accessible by a user via console opening 240com. Carrier traveling mat 358 and module(s) 363 may be removably coupled to the remainder of adjustable storage bin system 350 (e.g., to carrier 353) such that mat 358 and module(s) 363 may be passed through any suitable bin opening (e.g., opening 481, 481′, etc.). For example, once moved to position 358″, mat 358 and module(s) 363 may be passed from carrier space 353s through opening 481 into console space 241sr (e.g., onto support surface 241srl) manually by a user via either opening 240coa or opening 240com or automatically by any suitable mat ejection assembly (e.g., an assembly (e.g., electromechanical mechanism) configured to eject the mat outwardly along axis MSA automatically or in response to some user interface event). In some embodiments, module(s) 363 may remain electrically coupled to any suitable data and/or power sources for maintaining a functional relationship with any user device(s) 220ua that may be positioned on the mat when the mat is at least partially removed from carrier space 353s (e.g., the mat and module and user device may remain on support surface 241srl and continue charging a user's device while other items may be stored within carrier space 353s). In other embodiments, only object(s) (e.g., user device 220u) may be ejected through the carrier opening while the mat may remain within the carrier space.

In a particular use case, if a user is not positioning a user device 220ua on the mat, the mat may be lowered to its fully down position to maximize the amount of carrier space 353s accessible to a user above the mat. In some embodiments, a door movement assembly (e.g., assembly 489) may be configured like a garage door opener, whereby door 476 may translate from a closed position in an X-Z plane within opening 481 to an open position in an X-Y plane extending across space 353s within carrier 353 (e.g., as shown by open door 4760 of FIG. 2K), such that the open door may provide a shelf surface on which a user may position any suitable objects for storage thereon (e.g., the system may be configured to automatically open the door or otherwise provide such a shelf above the mat once the mat is lowered to an intermediate or fully down position (e.g., to protect any device(s) on the mat and to provide a sturdy surface for storing more objects)). In some embodiments, a carrier may have a side storage bin opening without an associated door, whereby the carrier space may be accessed by a user via that a side storage bin opening and a proximate console opening, which may or may not have its own associated door (e.g., opening 240cob may not include a door 240cobd and opening 481′ may not include a door 476′, such that openings 240cob and 481′ may always be exposed to one another and the carrier space may always be accessible via openings 240cob and 481′ by a user).

In some embodiments, there is provided a vehicle (e.g., vehicle 290) that may include a vehicle bin component (e.g., console 240c) defining a vehicle bin component space (e.g., space 241a), and a storage bin system (e.g., system 250) that may include a bin carrier (e.g., carrier 353) defining a carrier space (e.g., space 353s), a tray (e.g., tray 358), and a tray movement assembly (e.g., assembly 330, assembly 335, assembly 390, assembly 581, and/or the like) operative to control movement within the carrier space of the tray between a plurality of tray positions relative to the bin carrier, wherein the bin carrier may be at least partially positioned within the vehicle bin component space. In some embodiments, the vehicle may further include an electronic vehicle subsystem (e.g., subsystem 220f), the storage bin system may further include a device module (e.g., module 363), the device module may be physically coupled to the tray, the device module may be electrically coupled to the electronic vehicle subsystem, and the device module may be operative to electrically couple to a user electronic device (e.g., device 220u) when the user electronic device is positioned on the tray. In some embodiments, the device module may include a wireless charging module. In some embodiments, the device module may include a USB connector. In some embodiments, the vehicle bin component may include a center console (e.g., console 240c). In some embodiments, the vehicle bin component may include one of the following: a glove box (e.g., box 249g); an interior storage bin (e.g., box 249g); a door trim (e.g., door trim portion 249h); an overhead storage bin (e.g., portion 249i); a trunk trim quarter garnish (e.g., garnish 249j); a floor panel (e.g., portion 249k); a seat (e.g., portion 249l); an upper panel (e.g., panel 249m); or an instrument panel storage (e.g., panel 249m). In some embodiments, the vehicle may be one of the following: a road vehicle; a rail vehicle; a watercraft; or an aircraft. In some embodiments, the tray movement assembly comprises a push-push latch assembly (e.g., assembly 335). In some embodiments, the tray movement assembly comprises a locking multi-step assembly (e.g., assembly 330). In some embodiments, the tray movement assembly comprises a scissor-type assembly (e.g., assembly 581). In some embodiments, the tray movement assembly comprises a storage bin motor assembly (e.g., assembly 390). In some embodiments, the vehicle bin component space may include a bin space portion (e.g., portion 241sb) and a remaining space portion (e.g., portion 241sr), the bin carrier may be at least partially positioned within the bin space portion, the bin carrier may include a plurality of carrier walls (e.g., top wall 353a, bottom wall 353m, left wall 3531, right wall 353r, front wall 353f, and rear wall 353e of carrier 353) that may at least partially define the carrier space, a side storage bin opening (e.g., opening 481) that may extend through a carrier wall of the plurality of carrier walls, and the side storage bin opening may couple the carrier space with the remaining space portion. In some embodiments, a tray position (e.g., position 358″) of the plurality of tray positions may be aligned with the side storage bin opening. In some embodiments, the storage bin system may further include an ejection assembly (e.g., assembly 299) that may be configured to eject at least one of the following from the carrier space and into the remaining space portion via the side storage bin opening once the tray is at the tray position: the tray; or an object (e.g., device 220ua) positioned on the tray. In some embodiments, the vehicle bin component space may include a bin space portion and a remaining space portion, the bin carrier may be at least partially positioned within the bin space portion, the vehicle bin component may include a plurality of vehicle bin component walls that may at least partially define the vehicle bin component space, a vehicle bin component opening (e.g., opening 240coa) that may extend through a vehicle bin component wall (e.g., wall 240csw) of the plurality of vehicle bin component walls, and the vehicle bin component opening may couple the remaining space portion with an ambient space (e.g., space 298as) that is external to the vehicle bin component space. In some embodiments, the vehicle may also include a door (e.g., door 240coad), and a door movement assembly operative to control movement of the door between a first door position within the vehicle bin component opening and a second door position out from the vehicle bin component opening. In some embodiments, the storage bin system may further include a door (e.g., door 476), and a door movement assembly (e.g., assembly 489) that may be operative to control movement of the door between a first door position within the side storage bin opening and a second door position out from the side storage bin opening. In some embodiments, when the door (e.g., door 476) is in the second door position, a portion of the door (e.g., portion 4760) is positioned within the carrier space and is operative to support a user object (e.g., object 5a).

In some embodiments, there is provided a vehicle (e.g., vehicle 290) that may include a vehicle bin component (e.g., console 240c) defining a vehicle bin component space (e.g., space 241a), and a storage bin system (e.g., system 250) that may include a bin carrier (e.g., carrier 353) defining a carrier space (e.g., space 353s), a tray (e.g., tray 358), and a tray movement assembly (e.g., assembly 330, assembly 335, assembly 390, assembly 581, and/or the like) that may be operative to move the tray within the carrier space along a first axis (e.g., axis MMA) and move the tray out from the carrier space along a second axis (e.g., axis MSA) that is perpendicular to the first axis, wherein the bin carrier may be at least partially positioned within the vehicle bin component space.

In some embodiments, there is provided a vehicle (e.g., vehicle 290) that may include a vehicle bin component (e.g., console 240c) defining a vehicle bin component space (e.g., space 241a), and a storage bin system (e.g., system 250) that may include a bin carrier (e.g., carrier 353) defining a carrier space (e.g., space 353s), a tray (e.g., tray 358), and a tray movement assembly (e.g., assembly 330, assembly 335, assembly 390, assembly 581, and/or the like) that may be operative to control movement within the carrier space along a first axis (e.g., axis MMA) of the tray between a first tray position (e.g., position 358′) and a second tray position (e.g., position 358′ or position 358″), wherein the bin carrier may include a wall (e.g., wall 3531) with an opening (e.g., opening 481) for enabling a user to move the tray along a second axis perpendicular (e.g., axis X) to the first axis from the second tray position to a third tray position external from the carrier space, wherein the bin carrier may be at least partially positioned within the vehicle bin component space.

One, some, or all of the processes described with respect to FIGS. 1-5C may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 of a subsystem). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one subsystem to another directly or via any suitable network or bus or the like. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein may refer to and encompass any and all possible combinations of one or more of the associated listed items. As used herein, the phrase “at least one of” preceding a series of items, with the term “and” or “or” to separate any of the items, modifies the list as a whole, rather than each member of the list (i.e, each item) The phrase “at least one of” does not require selection of at least one of each item listed; rather, the phrase allows a meaning that includes at least one of any one of the items, and/or at least one of any combination of the items, and/or at least one of each of the items By way of example, the phrases “at least one of A, B, and C” or “at least one of A, B, or C” may each refer to only A, only B. or only C; any combination of A, B, and C; and/or at least one of each of A, B, and C. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may, optionally, be construed to mean “when” or “upon” or “in response to determining” or “in response to detecting,” depending on the context. Similarly, the phrase “if it is determined” or “if [a stated condition or event] is detected” may, optionally, be construed to mean “upon determining” or “in response to determining” or “upon detecting [the stated condition or event]” or “in response to detecting [the stated condition or event],” depending on the context.

As used herein, the terms “computer,” “personal computer,” “device,” “computing device,” “router device,” and “controller device” may refer to any programmable computer system that is known or that will be developed in the future. In certain embodiments, a computer may be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As used herein, the terms “component,” “module,” and “system” may be intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e.g., her and its and they) and vice versa Headings and subheadings, if any, are used for convenience only and do not limit the subject disclosure.

While there have been described adjustable storage bins for vehicles and methods for using the same, many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms, such as “left” and “right,” “up” and “down,” “front” and “back” and “rear,” “top” and “bottom” and “side,” “above” and “below,” “length” and “width” and “thickness” and “diameter” and “cross-section” and “longitudinal,” “X-” and “Y-” and “Z-,” and/or the like, may be used herein only for convenience, and that no fixed or absolute directional or orientational limitations are intended by the use of these terms. For example, the components of the apparatus can have any desired orientation. If reoriented, different directional or orientational terms may need to be used in their description, but that will not alter their fundamental nature as within the scope and spirit of the disclosure.

Therefore, those skilled in the art will appreciate that the concepts of the disclosure can be practiced by other than the described embodiments, which are presented for purposes of illustration rather than of limitation.

What is claimed is:

1. A vehicle comprising:
a vehicle bin component defining a vehicle bin component space; and
a storage bin system comprising:
a bin carrier defining a carrier space, wherein the bin carrier is at least partially positioned within the vehicle bin component space;
a tray; and
a tray movement assembly operative to control movement within the carrier space of the tray between a plurality of tray positions relative to the bin carrier.

2. The vehicle of claim 1, wherein:
the vehicle further comprises an electronic vehicle subsystem;
the storage bin system further comprises a device module;
the device module is physically coupled to the tray;
the device module is electrically coupled to the electronic vehicle subsystem; and
the device module is operative to electrically couple to a user electronic device when the user electronic device is positioned on the tray.

3. The vehicle of claim 2, wherein the device module comprises a wireless charging module.

4. The vehicle of claim 2, wherein the device module comprises a Universal Serial Bus (“USB”) connector.

5. The vehicle of claim 1, wherein the vehicle bin component comprises a center console.

6. The vehicle of claim 1, wherein the vehicle bin component comprises one of the following:
a glove box;
an interior storage component;
a door trim;
an overhead storage;
a trunk trim quarter garnish;
a floor panel;
a seat;
an upper panel; or
an instrument panel storage.

7. The vehicle of claim 1, wherein the vehicle is one of the following:
a road vehicle;
a rail vehicle;
a watercraft; or
an aircraft.

8. The vehicle of claim 1, wherein the tray movement assembly comprises a push-push latch assembly.

9. The vehicle of claim 1, wherein the tray movement assembly comprises a locking multi-step assembly.

10. The vehicle of claim 1, wherein the tray movement assembly comprises a scissor-type assembly.

11. The vehicle of claim 1, wherein the tray movement assembly comprises a storage bin motor assembly.

12. The vehicle of claim 1, wherein:
the vehicle bin component space comprises a bin space portion and a remaining space portion;
the bin carrier is at least partially positioned within the bin space portion;
the bin carrier comprises a plurality of carrier walls that at least partially defines the carrier space;
a side storage bin opening extends through a carrier wall of the plurality of carrier walls; and
the side storage bin opening couples the carrier space with the remaining space portion.

13. The vehicle of claim 12, wherein a tray position of the plurality of tray positions is aligned with the side storage bin opening.

14. The vehicle of claim 12, wherein the storage bin system further comprises an ejection assembly configured to eject at least one of the following from the carrier space and into the remaining space portion via the side storage bin opening once the tray is at the tray position:
the tray; or
an object positioned on the tray.

15. The vehicle of claim 12, wherein:
the vehicle bin component space comprises a bin space portion and a remaining space portion;
the bin carrier is at least partially positioned within the bin space portion;
the vehicle bin component comprises a plurality of vehicle bin component walls that at least partially defines the vehicle bin component space;
a vehicle bin component opening extends through a vehicle bin component wall of the plurality of vehicle bin component walls; and
the vehicle bin component opening couples the remaining space portion with an ambient space that is external to the vehicle bin component space.

16. The vehicle of claim 15, wherein the vehicle further comprises:
a door; and
a door movement assembly operative to control movement of the door between a first door position within the vehicle bin component opening and a second door position out from the vehicle bin component opening.

17. The vehicle of claim 12, wherein the storage bin system further comprises:
a door; and
a door movement assembly operative to control movement of the door between a first door position within the side storage bin opening and a second door position out from the side storage bin opening.

18. The vehicle of claim 17, wherein, when the door is in the second door position, a portion of the door is positioned within the carrier space and is operative to support a user object.

19. A vehicle comprising:
a vehicle bin component defining a vehicle bin component space; and
a storage bin system comprising:
a bin carrier defining a carrier space, wherein the bin carrier is at least partially positioned within the vehicle bin component space;
a tray; and
a tray movement assembly operative to:
move the tray within the carrier space along a first axis; and
move the tray out from the carrier space along a second axis that is perpendicular to the first axis.

20. A vehicle comprising:
a vehicle bin component defining a vehicle bin component space; and
a storage bin system comprising:
a bin carrier defining a carrier space, wherein the bin carrier is at least partially positioned within the vehicle bin component space;
a tray; and
a tray movement assembly operative to control movement within the carrier space along a first axis of the tray between a first tray position and a second tray position, wherein the bin carrier comprises a wall with an opening for enabling a user to move the tray along a second axis perpendicular to the first axis from the second tray position to a third tray position external from the carrier space.
